(19) United States
(12) Patent Application Publication
(10) Pub. No.: US 2009/0248866 A1
(43) Pub. Date: Oct. 1, 2009

(54) CONNECTION CONTROL METHOD AND CONNECTION SYSTEM

(75) Inventors: Yuki Fujishima, Kawasaki (JP); Nobuyuki Kanaya, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/414,657

(22) Filed: Mar. 30, 2009

(30) Foreign Application Priority Data
Mar. 31, 2008 (JP) 2008-090784

(51) Int. Cl. G06F 15/173; G06F 15/16

(52) U.S. Cl. 709/224; 726/11

(57) ABSTRACT

A connection control method includes: a transmitting step of transmitting a request for provision of a function by a transmitting unit; a first storing step of storing a task involving information having a disclosure restriction set thereon, and the site of a support device that provides a function to support execution of the task by processing the information, the task being associated with the site of the support device; a first retrieving step of retrieving the site of the support device stored in the first storing step associated with the task to be supported in response to the request; and a controlling step of restricting connections with other devices by controlling the transmitting unit to transmit the request to the support device located at the site retrieved in the first retrieving step and not to transmit the request to the other devices when the request transmitted in the transmitting step is a request for a support for execution of the task.

### CROSS-REFERENCE TO RELATED APPLICATION

This application is based upon and claims the benefit of priority of the prior Japanese Patent Application No. 2008-090784, filed on Mar. 31, 2008, the entire contents of which are incorporated herein by reference.

### FIELD

The present invention generally relates to a connection control method and a connection system, and more particularly, to a connection control method for controlling connections with devices to be used in execution of business tasks, and a connection system that includes devices to be connected to the devices that support execution of the business tasks.

### BACKGROUND

There has been a known monitoring device that can monitor current connections based on the access logs that record the past connection allowing conditions (see Japanese Unexamined Patent Publication No. 2000-148276, for example).

Such a monitoring device characteristically monitors connections, based on the time zone or the like of the connections allowed in the past obtained by extracting the access states indicating the times or the like at which connections were allowed in the past, and on the current time or the like at which a connection is allowed.

There has also been a monitoring program for monitoring connections, based on a list such as a white list on which the connection destinations confirmed to be safe in advance (see “Phishing Prevention Tool of White List Type available from Comodo”, [online], September 2006, [read on Mar. 11, 2008], the Internet <URL:http://www.oshiete-kun.net/archives/2006/09/comodo.html>, for example).

However, the above monitoring device monitors the current connection, based on the past access conditions recorded in the access logs. As a result, the monitoring device has the problem of poor monitoring accuracy.

More specifically, after allowing a connection based on the past access records, the monitoring device cannot monitor the connection having a new connection destination through a technique such as HTTP (HyperText Transfer Protocol) redirection or redirection with scripts or metatags.

The above monitoring device also monitors connections, regardless of the usage of the connected device. Therefore, the monitoring device cannot provide flexible monitoring in accordance with the need that depends on the usage of each device.

More specifically, the above monitoring device performs uniform monitoring whether or not the subject device is being used in execution of a task involving highly confidential information. Therefore, the monitoring device continues monitoring connections even when the need for monitoring information leakage to connection destinations is not great. As a result, a decrease in the usability of the monitoring device is caused.

Furthermore, according to the above monitoring program, it is necessary not only to check the safety of a connection destination before registering the connection destination on the white list, but also to regularly check the safety after the registration. Therefore, the monitoring device cannot efficiently generate and maintain a white list.

### SUMMARY

According to an aspect of the present invention, there is provided a connection control method including: transmitting a request for provision of a function through a transmitting unit; storing a task involving information having a disclosure restriction set thereon, and a site of a support device that provides a function to support execution of the task by processing the information, the task being associated with the site of the support device; retrieving the site of the support device stored associated with the task to be supported in response to the request; and restricting connections with other devices by controlling the transmitting unit to transmit the request to the support device located at the site retrieved and not to transmit the request to the other devices when the request transmitted is a request for a support for execution of the task.

### BRIEF DESCRIPTION OF THE DRAWINGS

FIG. 1 illustrates the structure of a connection system in accordance with an embodiment of the present invention;

FIGS. 2A and 2B illustrate the procedures to be carried out by the connection system to execute tasks;

FIGS. 3A and 3B illustrate the procedures to be carried out by the in-house system to control connections;

FIG. 4 is a functional block diagram showing the structure of the transmission device;

FIG. 5 shows an example hardware structure of the transmission device;

FIGS. 6A through 6C are flowcharts showing an example of the actual transmitting operation to be performed by the transmitting unit;

FIG. 7 shows an example of the relationships between the business tasks and the sites to be transmitted;

FIG. 8 shows an example of the execution log file stored in the memory unit;

FIGS. 9A and 9B show an example of a directory table stored in the memory unit;

FIGS. 10A through 10E show examples and server lists and the likes stored in the memory unit;

FIGS. 11A through 11E show examples of the transition pattern list and site lists stored in the memory unit;

FIG. 12 is a functional block diagram showing an example structure of the extracting unit;

FIG. 13 is a flowchart showing an example of the site information extracting operation to be performed by the site information extracting unit;

FIG. 14 is a flowchart showing an example of the extracting operation to be performed by the extracting unit;

FIG. 15 is a flowchart showing an example of the associating operation to be performed by the associating unit;

FIG. 16 is a functional block diagram showing an example structure of a terminal device;

FIG. 17 is a flowchart showing an example of the retrieving operation to be performed by the retrieving unit;

FIG. 18 is a flowchart showing an example of the checking operation to be performed by the checking unit;

FIG. 19 is a flowchart showing a part of a control operation to be performed by the control unit;

FIG. 20 is a flowchart showing the other part of the control operation to be performed by the control unit;

FIG. 21 is a flowchart showing an example of the checking operation to be performed by the checking unit in a second embodiment of the present invention; and

FIG. 22 is a flowchart showing an example of the retrieving operation to be performed by the retrieving unit in the second embodiment.

### DESCRIPTION OF EMBODIMENTS

The following is a description of embodiments of the present invention, with reference to the accompanying drawings.

### First Embodiment

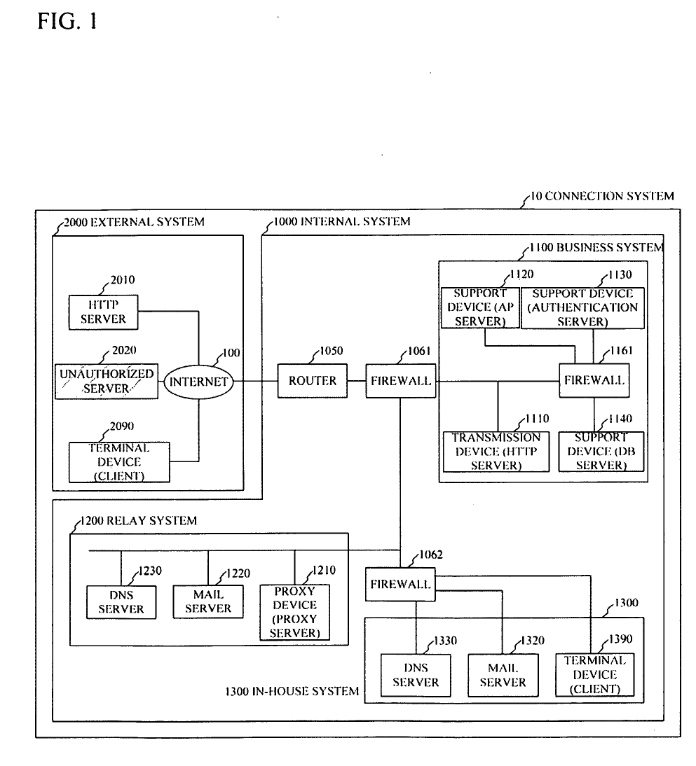

FIG. 1 illustrates an example structure of a connection system that includes a terminal device for executing a connection control program that may be stored in a computer-readable recording medium according to an aspect of the present invention.

The connection system 10 shown in FIG. 1 includes an internal system 1000 and an external system 2000. The internal system 1000 and the external system 2000 are connected so as to exchange information with each other. The internal system 1000 is a system that is used inside an organization that carries out business activities involving information for which disclosure restrictions are set.

The information for which disclosure restrictions are set includes not only personal information or trade secrets having disclosure restrictions set by the Private information Protection Law or the Act against Unfair Competition, but also the information that is managed as secrets by the organization carrying out the business activities or persons who belong to the organization.

The business activities involving the information for which disclosure restrictions are set includes not only the personnel activities involving personal information that associates the salaries of employees with the names of the employees and the business activities involving the information about the trade secrets that associate the addresses and telephone numbers of customers with the names of the customers, but also the business activities involving the information about the financial details of banks managed for internal use only by a banking organization that performs banking activities.

The internal system 1000 includes a router 1050, firewalls 1061 and 1062, a business system 1100, a relay system 1200, and an in-house system 1300.

The router 1050 is formed with a special-purpose device or a personal computer on which the software for realizing a router function is installed, for example. The router 1050 is connected to the external system 2000 and the firewall 1061. The router 1050 determines the transmission route of the information to be relayed, and transmits and relays the information to the determined route.

The firewalls 1061 and 1062 are each formed with a special-purpose device or a personal computer on which the software for realizing a firewall function is installed, for example. The firewall function is the function that cuts off communications that comply with or does not comply with the regulations set to prevent unauthorized connections. More specifically, the firewall 1061 cuts off unauthorized connections by allowing a communication only when the communication to be made via the firewall 1061 is captured, and the number allotted to the communication port or the like to be used for the captured communication complies with the regulations defining the port numbers for allowing communication beforehand.

The firewall 1061 is connected to the router 1050, the firewall 1062, and the business system 1100. The firewall 1062 is connected to the firewall 1061, the relay system 1200, and the in-house system 1300.

The business system 1100 includes a transmission device 1110, support devices 1120 through 1140, and a firewall 1161. The business system 1100 is connected to the firewall 1061. The business system 1100 supports business activities in response to requests from the external system 2000 and the in-house system 1300 connected to the business system 1100 via the firewall 1061.

The relay system 1200 includes a proxy device 1210, a mail server 1220, and a DNS (Domain Name System) server 1230. The relay system 1200 is connected to the firewalls 1061 and 1062. The relay system 1200 relays the information to be transmitted and received by the business system 1100 and the external system 2000 connected to the relay system 1200 via the firewall 1061 and by the in-house system 1300 connected to the relay system 1200 via the firewall 1062.

The in-house system 1300 includes a mail server 1320, a DNS server 1330, and a terminal device 1390. The in-house system 1300 is connected to the firewall 1062. The in-house system 1300 is the system the company organization carrying out the business activities uses to carry out the activities. On other words, the in-house system 1300 carries out the business activities, supported by the business system 1100 or the external system 200 connected to the in-house system 1300 via the firewall 1062.

The in-house system 1300 is also connected to the external system 2000 to use the mail distribution function or the like of the external system 2000, not for business activities but for personal activities such as sending and receiving private mail or reading Web pages during a short break from work.

The personal activities unrelated to any business activities are carried out not only when the terminal device 1390 or 2090 is not supported by the business system 1100 and is not carrying out any activity (this situation will be hereinafter referred to simply as a no-task performing state), but also when the terminal device 1390 or 2090 is performing some business activity (this situation will be hereinafter referred to simply as a task performing state). If the information handled in the business activity is information on which a disclosure restriction is set, the information might be disclosed beyond the disclosure range defined by the disclosure restriction, when a personal activity is conducted during a task performing state.

Particularly, in a case where the device connected for personal activities is managed by a person with unauthorized purposes, or where the control of the device is put into the hands of such a person, there is a high probability that the information flows outside. Therefore, personal connections to the terminal device 1390 or 2090 in the task performing state should be restricted with high precision. Such a device under unauthorized control will be hereinafter referred to simply as an unauthorized server.

The unauthorized purposes include transmitting a program such as a “worm” or “virus” to the connected terminal device 1390 or 2090 so as to modify, erase, or expose the information being processed by the terminal device 1390 or 2090, for example.

However, constantly restricting personal connections reduces the usability of the in-house system 1300, while preventing information leakage.

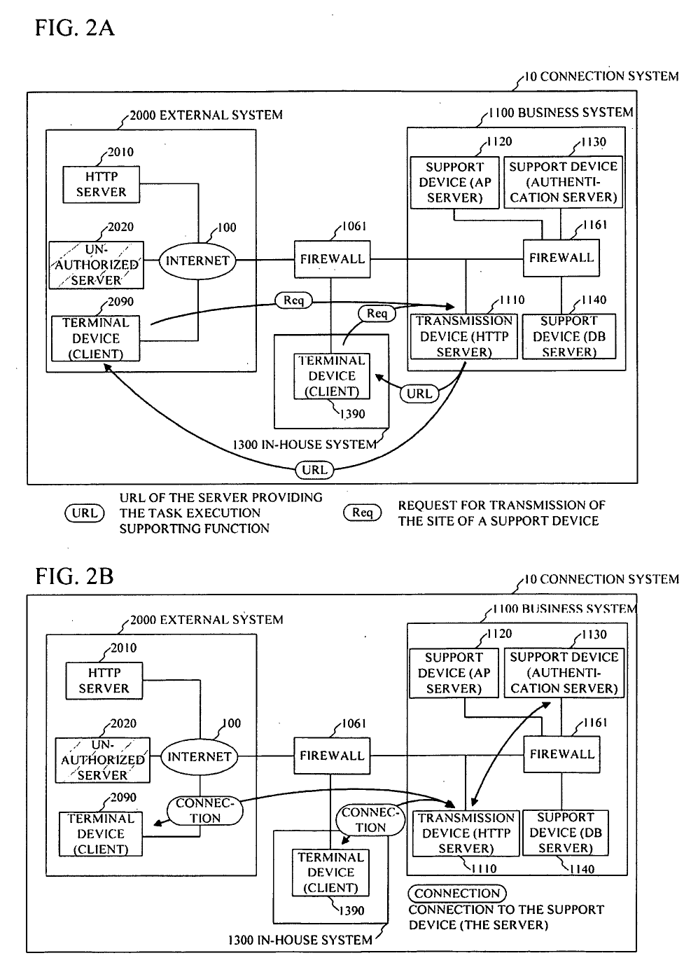

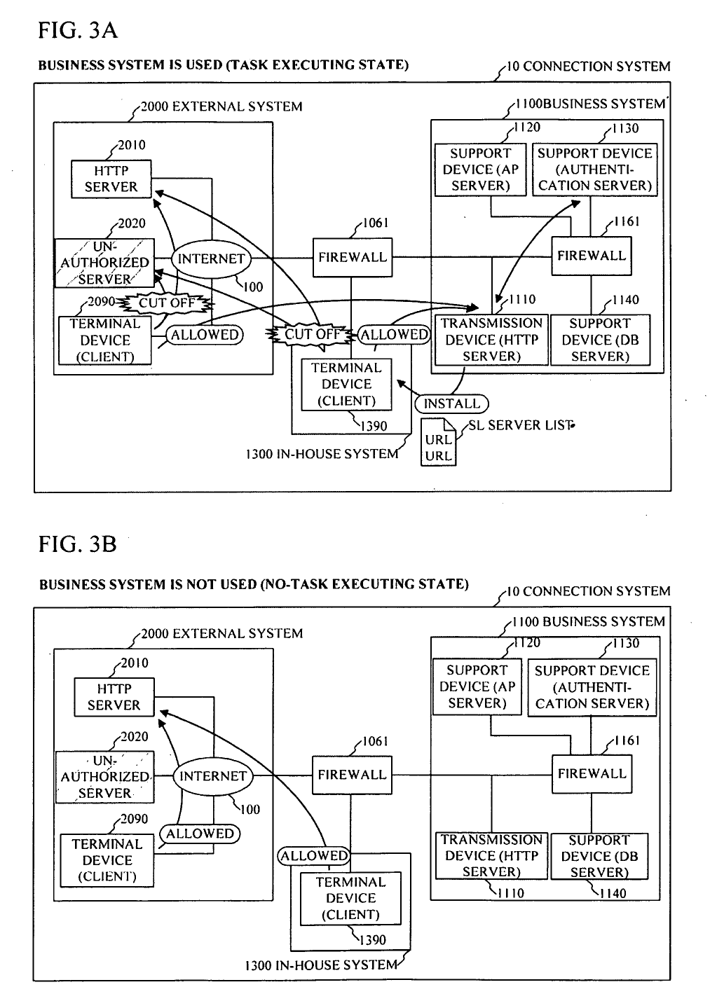

Referring now to FIGS. 2A and 2B, the procedures to be carried out by the in-house system 1300 to perform business activities are described. After that, the procedures to be carried out by the in-house system 1300 to restrict connections and prevent a decrease in usability are described, with reference to FIGS. 3A and 3B.

FIGS. 2A and 2B schematically show the procedures to be carried out by the connection system 10 to perform business activities.

As shown in FIG. 2A, the terminal devices 1390 and 2090 of the connection system 10 first transmit a request (hereinafter referred to simply as the transmission request) for transmission of the sites of the support devices 1120 through 1140 of the business system 1100 providing the function to support business activities (hereinafter referred to simply as the business activity supporting function), to the transmission device 1110 serving as a HTTP (HyperText Transfer Protocol). More specifically, the terminal devices 1390 and 2090 send the request for transmission of the predetermined Web (World Wide Web) page showing the sites of the support devices 1120 through 1140, to the transmission device 1110.

In response to the received request, the transmission device 1110 performs a transmitting operation to transmit the URLs (Uniform Resource Locators) representing the sites of the support devices 1120 through 1140 to the terminal devices 1290 and 2090. The transmitting operation to transmit the sites to the terminal device 2090 is expressed by functions, and therefore, will be hereinafter referred to simply as the transmission functions.

The URLs to be transmitted by the transmission device 1110 represent not only the sites of the support devices 1120 through 1140 in the form of server names and the likes, but also the sites of programs or Web pages to be used for supporting tasks at the support devices 1120 through 1140, such as path names, and the information representing the method to be used for receiving supports such as scheme names and port numbers. Particularly, the transmission functions include the function for creating a HTTP redirection request to be transmitted to the terminal devices 1390 or 2090, and the function for dynamically generating HTML metatags, scripts, links, and the likes.

After receiving the URLs representing the sites, the terminal devices 1390 and 2090 are connected to the support devices 1120 through 1140 located at the sites represented by the received URLs via the transmission device 1110 or the like, and receive the supports for business activities, as shown in FIG. 2B.

FIGS. 2A and 2B and FIGS. 3A and 3B, which will be described later, do not show the devices and systems such as the firewall 1062 and the relay system 1200 actually located between the firewall 1061 and the terminal device 1390.

Referring now to FIGS. 3A and 3B, the procedures to be carried out by the in-house system 1300 to control connections are described. FIGS. 3A and 3B schematically show the procedures to be carried out by the in-house system 1300 to control connections.

The transmission device 1110 stores execution logs as the execution history of the transmission functions executed in response to transmission requests (the transmission functions will be hereinafter referred to simply as the executed functions). The execution logs contain the information that associates the names of the transmission functions for transmitting URLs in response to transmission requests (the names are of the executed functions) with the arguments used in the execution functions, the information transferred with the arguments, and the execution dates and times of the functions.

First, the transmission device 1110 extracts the information indicating the URLs transferred with the arguments from the execution logs, based on the arguments used in the transferring of the URLs representing the sites in the transmission functions, and the names of the transmission functions. The transmission device 1110 then generates a site list SL that associates the sites of the support devices 1120 through 1140 extracted from the execution logs with the tasks to be supported by the support devices 1120 through 1140.

After that, the site list and the connection control program for controlling connections with the use of the site list are installed on the terminal devices 1390 and 2090, as shown in FIG. 3A. The connection control program installed on the terminal devices 1390 and 2090, which may be loaded from a computer-readable recording medium, is the program for allowing connections to the support devices 1120 through 1140 located at the sites associated with the tasks to be supported by the business system 1100, and cutting off connections to devices 2010 and 2020, while the business system 1100 is in use (in the task performing state).

Particularly, since the device 2020 shown in FIG. 3A (and FIG. 3B) is an unauthorized server, a connection to the device 2020 should be cut off when the terminal devices 1390 and 2090 perform tasks.

Meanwhile, when the business system 1100 is not in use (or in the no-task performing state), the connection control program executed by the terminal devices 1390 and 2090 does not monitor connections to other devices including the devices 2010 and 2020.

In this structure, connections to the support devices located at the sites stored beforehand in association with tasks are established, but connections to the other devices are not allowed, when tasks are supported. Accordingly, connections to devices can be controlled with high precision, and a decrease in usability can be prevented.

Referring back to FIG. 1, explanation of the structure of the connection system 10 is now resumed, starting from explanation of the structure of the business system 1100.

The transmission device 1110 is formed with a personal computer or a server device on which Web server software such as Apache is installed. The transmission device 1110 is connected to the firewalls 1061 and 1062, and functions as a Web server. Particularly, the transmission device 1110 has a site transmitting function to transmit a Web page (or a HTML file) written in HTML (HyperText Markup Language) in response to a transmission request according mainly to HTTP (HyperText Transfer Protocol). Accordingly, the transmission device 1110 will be hereinafter also referred to as the HTTP server. The requests to be received by the transmission device 1110 and the information to be transmitted by the transmission device 1110 will be described later.

The transmission device 1110 also has an information extracting function to extract the site list showing the URLs representing the sites of the support devices 1120 through 1140 from the execution logs. Accordingly, the transmission device 1110 will be hereinafter also referred to as the information extraction device 1110.

In this embodiment, the transmission device 1110 is described as a device having both the site transmitting function and the information extracting function. However, the present invention is not limited to that, and the transmission device 1110 may have only the site transmitting function, and the connection system 10 may include a device having the information extracting function independently of the transmission device 1110.

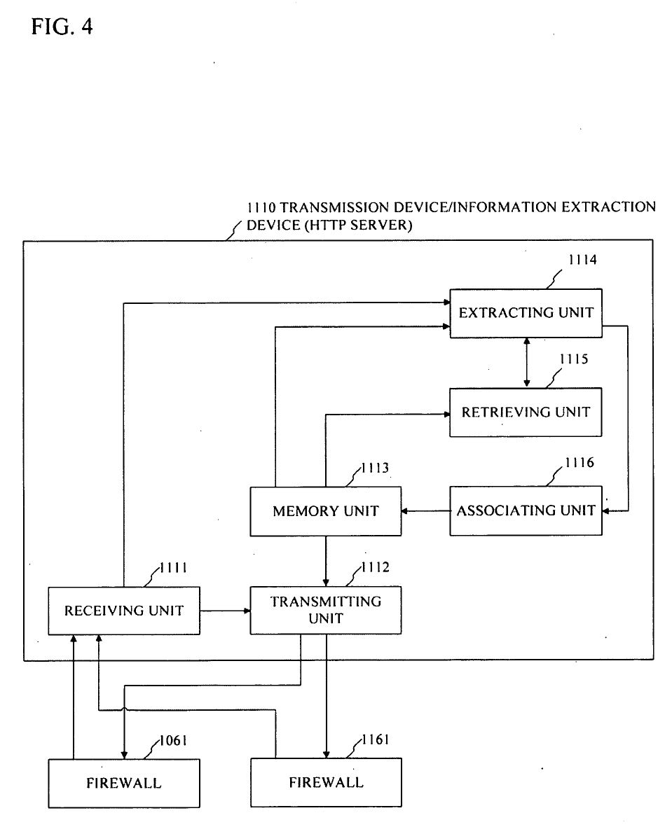

Referring now to FIG. 4, the functions of the transmission device 1110 are described. FIG. 4 is a functional block diagram showing the structure of the transmission device 1110.

The transmission device 1110 includes a receiving unit 1111, a transmitting unit 1112, a memory unit 1113, an extracting unit 1114, a retrieving unit 1115, and an associating unit 1116.

The functions of the extracting unit 1114, the retrieving unit 1115, and the associating unit 1116 are realized by software control performed by the transmission device 1110.

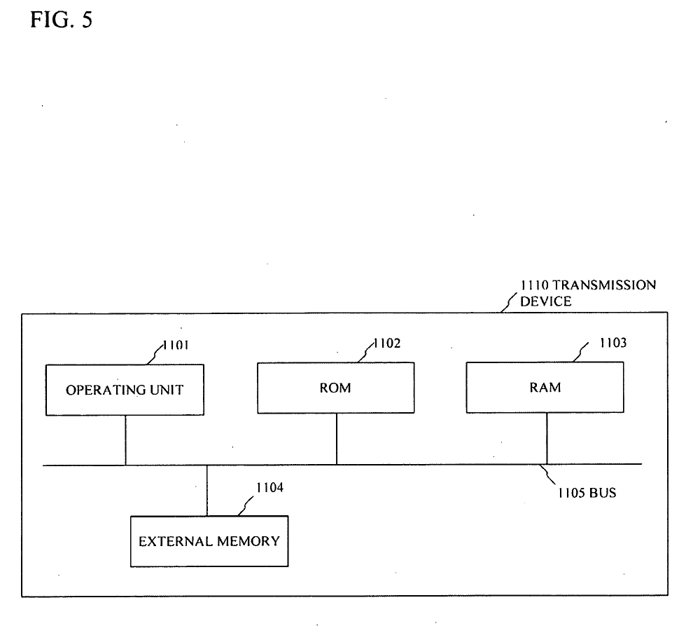

Referring now to FIG. 5, the hardware structure of the transmission device 1110 to be used for performing the software control is described. FIG. 5 shows an example hardware structure of the transmission device 1110 to be used for performing the software control.

The transmission device 1110 includes an operating unit 1101 such as a CPU (Central Processing Unit), a ROM (Read-Only Memory) 1102 such as an EPROM (Erasable Programmable Read-Only Memory) or an EEPROM (Electrically Erasable Programmable Read-Only Memory), a RAM (Random Access Memory) 1103 formed with a volatile memory such as a DRAM (Dynamic RAM) or a SRAM (Static RAM) and a nonvolatile memory such as a NVRAM (NonVolatile RAM), and an external memory 1104 formed with a hard disk or the like. The operating unit 1101, the ROM 1102, the RAM 1103, and the external memory 1104 are connected to one another by a bus 1105.

The software control is performed by the operating unit 1101 reading a program stored in the ROM 1102 or the external memory 1104, and carrying out an operation in accordance with the read program. The data of the operation result is written into the RAM 1103. Particularly, the data that needs to be backed up when the power is turned off is written into the NVRAM.

Referring back to FIG. 4, explanation of the structure of the transmission device 1110 is now resumed.

The receiving unit 1111 is formed with a network card, for example. The receiving unit 1111 is connected to the firewalls 1061 and 1062, the transmitting unit 1112, and the extracting unit 1114. The receiving unit 1111 performs a receiving operation to receive a transmission request and an extraction request transmitted from the terminal device 1390 or 2090. The receiving unit 1111 also outputs the received transmission request to the transmitting unit 1112, and outputs the received extraction request to the transmitting unit 1112 and the extracting unit 1114. The extraction request is a request for extraction of the site list.

In this embodiment, the receiving unit 1111 receives the extraction request. However, the present invention is not limited to that arrangement, and the transmission device 1110 may be connected to an input device such as a keyboard, a mouse, or a touch panel, and may obtain the extraction request from the input device.

Like the receiving unit 1111, the transmitting unit 1112 is formed with a network card, for example, and is connected to the firewalls 1061 and 1062, the receiving unit 1111, and the memory unit 1113.

After obtaining the extraction request from the receiving unit 1111, the transmitting unit 1112 obtains the site list extracted by the extracting unit 1114 as described later from the memory unit 1113. The transmitting unit 1112 transmits the extraction request to the terminal device 1390 or 2090.

The transmitting unit 1112 also performs a later described actual transmitting operation in response to the transmission request received by the receiving unit 1111. By doing so, the transmitting unit 1112 performs the transmitting operation (or the transmission function) to transmit the URLs representing the sites of the support devices 1120 through 1140 to the terminal device 1390 or 2090.

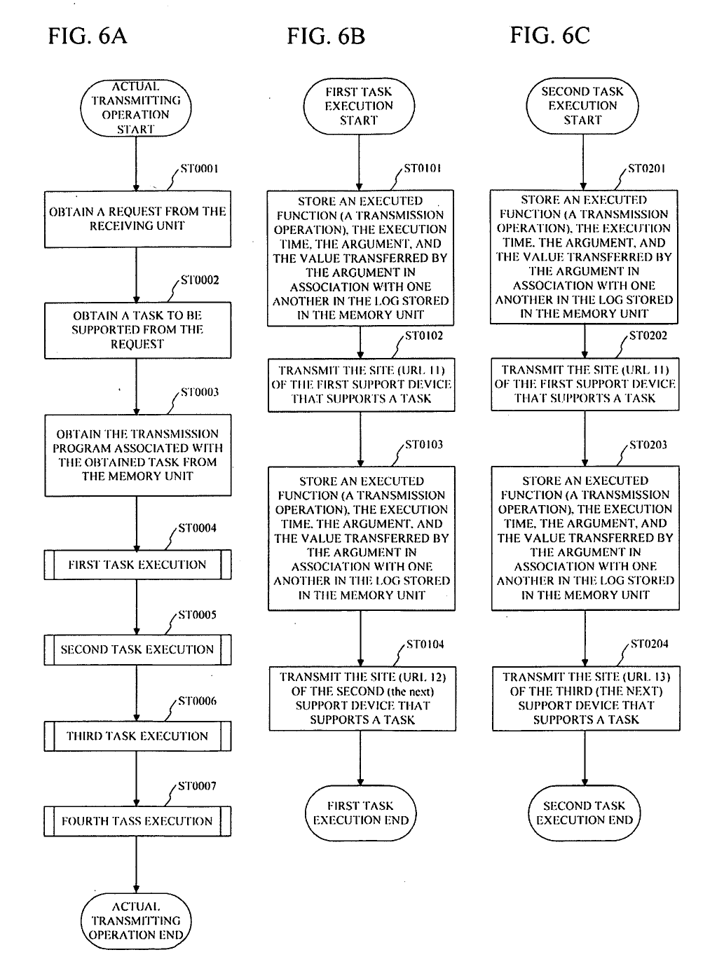

Referring now to FIGS. 6A through 6C, the actual transmitting operation to be performed by the transmitting unit 1112 is described. FIGS. 6A through 6C are flowcharts showing an example of the actual transmitting operation to be performed by the transmitting unit 1112.

Referring first to FIG. 6A, the actual transmitting operation to be performed by the transmitting unit 1112 is described.

The transmitting unit 1112 obtains a transmission request from the receiving unit 1111 (step ST0001). Based on the transmission request, the transmitting unit 1112 then obtains the task requiring a support (step ST0002). After that, the transmitting unit 1112 obtains the transmission program for the obtained task from the memory unit 1113 (step ST0003).

In this embodiment, the transmission device 1110 stores different transmission programs for different tasks. For example, the transmission programs to be executed in this embodiment have names that are defined by the respective tasks, but the present invention is not limited to those programs.

The transmitting unit 1112 next performs first through fourth business tasks that will be described later (steps ST0004 through ST0007). After that, the transmitting unit 1112 ends the actual transmitting operation. The business tasks include the procedures for executing one or more transmission functions to transmit the sites of the support devices 1120 through 1140 that supports the tasks of which contents are the same or related to one another in a certain aspect.

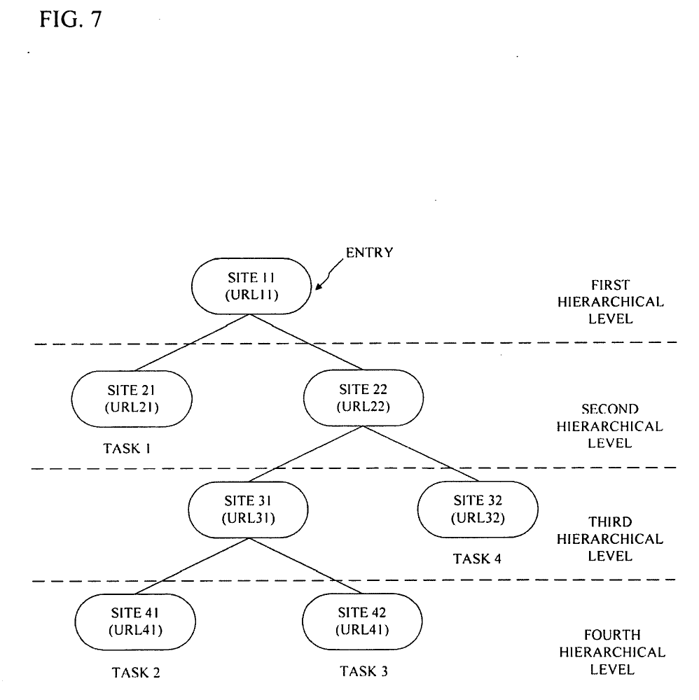

Referring now to FIG. 7, the relationship between the business tasks and the URLs representing the sites to be transmitted through execution of the business tasks is described. FIG. 7 shows an example of the relationship between the business tasks and the sites to be transmitted by executing the business tasks.

In this embodiment, the transmitting unit 1112 executes business tasks 1 through 4 as the first through fourth business tasks, in response to transmission requests for predetermined tasks. However, the present invention is not limited to that arrangement, and the transmitting unit 1112 may execute a single business task or more than four business tasks.

As shown in FIG. 7, the transmitting unit 1112 first executes the business task 1 to transmit a URL 21 after a URL 11. The transmitting unit 1112 then executes the business task 2 to transmit the URL 11, a URL 22, a URL 31, and a URL 41 in this order. After that, the transmitting unit 1112 executes the business task 3 to transmit the URL 11, the URL 22, the URL 31, and a URL 42 in this order. Lastly, the transmitting unit 1112 executes the business task 4 to transmit the URL 11, the URL 22, and a URL 32 in this order.

In each of the business tasks, the URL the transmitting unit 1112 first transmits is the URL or entry belonging to the first hierarchical level. In each of the business tasks, the URLs to be transmitted second, third, and fourth by the transmitting unit 1112 are the URLs belonging to the second, third, and fourth hierarchical levels, respectively.

Referring back to FIG. 6B, the first business task to be executed by the transmitting unit 1112 is described.

The transmitting unit 1112 first stores the transmission function (or the transmitting operation) to be executed, the execution time of the transmission function, the argument of the transmission function, and the value to be transferred with the argument in association with one another in the execution logs in the memory unit 1113 (step ST0101). The transmitting unit 1112 then transmits the site (the URL 11) of a first support device for supporting a business task (step ST0102).

The first support device is the support device 1120, and the second and third support devices described later are the support devices 1130 and 1140. However, the present invention is not limited to that arrangement.

After that, the transmitting unit 1112 stores the executed function, the execution time, the argument, and the value transferred with the argument in association with one another in the execution logs in the memory unit 1113 (step ST0103).

The transmitting unit 1112 then transmits the site (the URL 21) of the second support device 1130 that supports a business task (step ST0104). After that, the transmitting unit 1112 ends the transmitting operation.

The second business task to be executed by the transmitting unit 1112 shown in FIG. 6C is almost the same as the first business task to be executed by the transmitting unit 1112 shown in FIG. 6B, and therefore, explanation of it is omitted here. In the second business task, the URL 22 is transmitted after the URL 11, and the URL 31 and the URL 41 are then transmitted in this order, though not shown. Likewise, the third business task is to be executed by the transmitting unit 1112 to transmit the URL 11, the URL 22, the URL 31, and the URL 42, each representing a site, in this order. The fourth business task is to be executed by the transmitting unit 1112 to transmit the URL 11, the URL 22, and the URL 32, each representing a site, in this order.

Referring back to FIG. 4, explanation of the transmission device 1110 is now resumed.

The memory unit 1113 is formed with the RAM 1103 or the external memory 1104. The memory unit 1113 stores an execution log file FL that is an electronic file storing the execution logs.

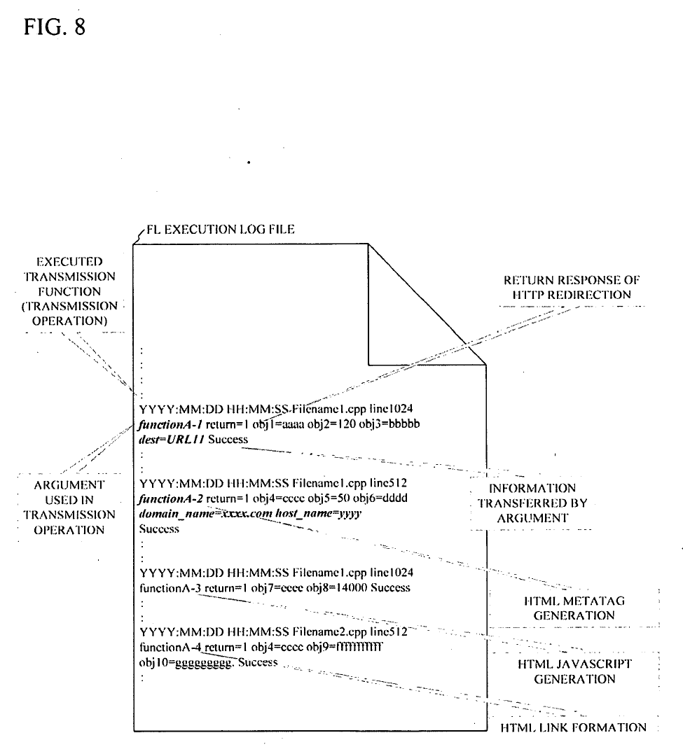

Referring now to FIG. 8, the execution log file FL stored in the memory unit 1113 is described. FIG. 8 shows an example of the execution log file FL stored in the memory unit 1113.

The execution log file FL shown in FIG. 8 stores the execution times of each executed function, the name of the source file describing the procedures for retrieving the executed function, the line describing the procedures in the source file, the name of the executed function, the returned value of the executed function, the argument of the executed function, the value transferred with the argument, and the execution state of the executed function in association with one another in a single line.

As shown in FIG. 8, the execution log file FL stores the execution logs of functions for generating HTTP redirection requests to be transmitted to the terminal device 1390 or 2090, and the transmission functions for dynamically generating HTTL metatags, scripts, links, and the likes. The execution logs are obtained by appropriately supporting tasks beforehand between the construction of the business system 1100 and the activation of the business system 1100.

In this structure, the functions for generating HTTP redirection requests and the URLs to be transmitted by the transmission functions dynamically generating the HTML metatags, scripts, links, and the likes are extracted from the appropriate logs obtained between the construction of the business system 1100 and the activation of the business system 1100. Accordingly, the information for accurately restricting manipulated connections with unauthorized servers can be extracted with the use of the technology involving HTTP redirection or the like.

The transmission functions are the functions for transmitting the sites of the support devices 1120 through 1140. Each of the sites of the support devices 1120 through 1140 may be transferred with a single argument used by the corresponding executed function, as in an argument “dest”. Alternatively, each of the sites of the support devices 1120 through 1140 may be transferred with two arguments used by the corresponding executed function, as in arguments “domain_name” and “host_name”.

In this embodiment, the each of the sites of the support devices 1120 through 1140 is transferred to the executed function with one or two arguments. However, the present invention is not limited to that arrangement, and each site may be transferred with three or more arguments.

The memory unit 1113 also stores a directory table that associates the transmission programs to be executed with the storage locations in the execution logs about executed transmission programs.

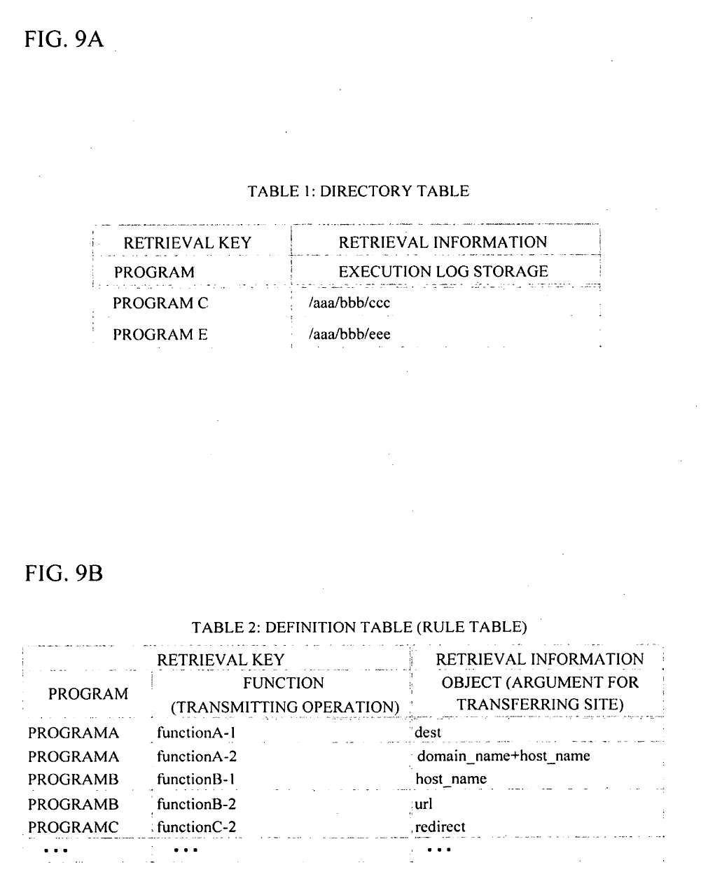

Referring now to FIG. 9A, the directory table stored in the memory unit 1113 is described. FIG. 9A shows an example of the directory table stored in the memory unit 1113.

Table 1 shown in FIG. 9A is an example of the directory table. Table 1 has a program field and an execution log storage field. The program field shows the names of the transmission programs. The execution log storage field shows the information indicating the directory storing the execution log of the transmission program of the name stored in the same line. The program field is a key field.

The memory unit 1113 also stores a rule table that associates transmission programs to be executed with the transmission functions to be called by the transmission programs and the arguments for transferring the information indicating the sites of the support devices 1120 through 1140 to the transmission functions. The information stored in the rule table defines the arguments for transferring the information indicating the sites.

Referring now to FIG. 9B, the rule table stored in the memory unit 1113 is described. FIG. 9B shows an example of the rule table stored in the memory unit 1113.

Table 2 shown in FIG. 9B is an example of the rule table. Table 2 has a program field, a function field, and an object field. The program field shows the names of the transmission programs. The function field shows the names of the transmission functions each to be called by the transmission program of the name stored in the same line. The object field shows the names of the arguments each for transferring the information indicating the site to the transmission function of the name stored in the same line.

The sites to be transferred with the arguments with reference to the information “dest” and “domain_name+host_name” stored as the first and second records in the object field are now described.

The information “dest” indicates that the information transferred with the argument “dest” is the information (or the URL) representing the site of the corresponding support device. The information “domain_name+host_name” indicates that the information formed by adding the information transferred with the argument “host_name” to the information transferred with the argument “domain_name” is the information representing the site of the corresponding support device.

More specifically, the information “URL 11” transferred with the argument “dest” of the transmission function “function A-1” is the URL representing the site transmitted to the terminal device 1390 or 2090, as shown in FIG. 8. The information “yyyy.xxxx.com” formed by adding the information “yyyy” transferred with the argument “host-name” to the information “xxxx.com” transferred with the argument “domain_name” of the transmission function “function A-2” is the transmitted URL.

The memory unit 1113 also stores the site information that associates the URLs representing the sites of the support devices 1120 through 1140 extracted from the execution logs by the later described extracting unit 1114, with the extracting order. Indicating the sites of the support devices 1120 through 1140 that are servers, the site information will be hereinafter also referred to as the server list.

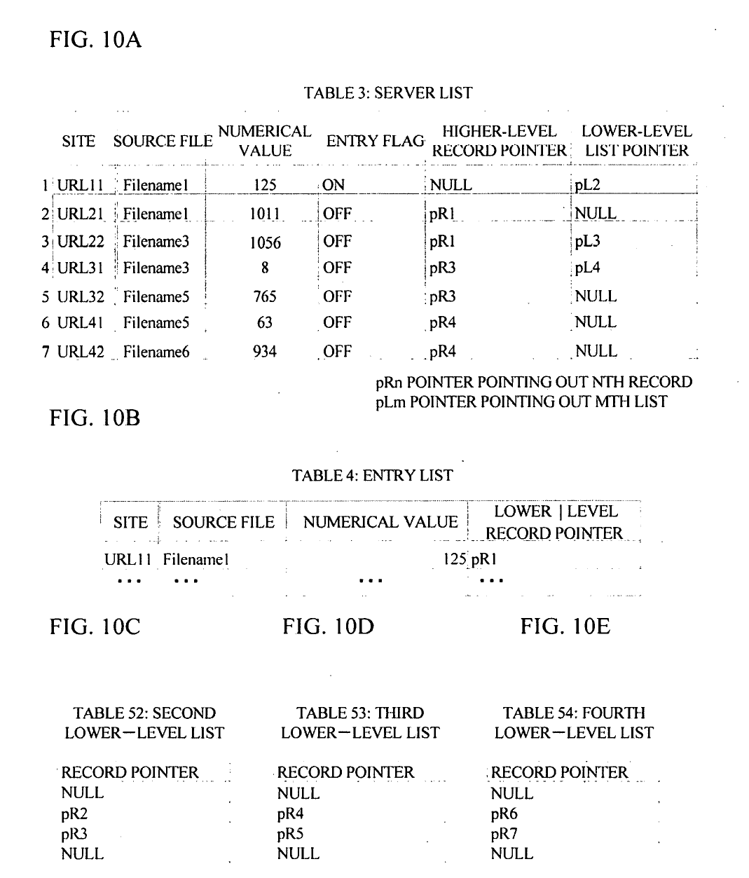

Referring now to FIGS. 10A through 10E, the server list and the likes stored in the memory unit 1113 are described. FIGS. 10A through 10E show examples of the server list and the likes stored in the memory unit 1113.

Table 3 shown in FIG. 10A is an example of the server list. Table 3 shows the sites of the support devices 1120 through 1140, which are servers. For ease of explanation, Table 3 is in the form of a table. However, Table 3 may be in the form of a list that shows the same contents. Accordingly, Table 3 will be hereinafter also referred to as the server list.

Table 3 has a site field, a source file field, a numeric value field, an entry flag field, a higher-level record pointer field, and a lower-level list pointer field.

The site field shows the URLs representing the sites extracted by the extracting unit 114. The source file field shows the names of the source files in which the procedures for calling the transmission functions each for transmitting the URL stored in the same record. The numeric value field shows the information to be added a spot behind the URL stored in the same record. For example, the numeric field may store the port numbers or the arguments of CGIs (common Gateway Interfaces). The numeric values may be determined based on the functions provided by the support devices 1120 through 1140 that are the servers of which sites are represented by the added URLs. If the subject support device is a FTP (File Transfer Protocol) server, for example, the numeric value is “21”; which is the reference port number.

The entry flag field shows flags. Each of the flags is “ON” if the URL stored in the same record is an entry belonging to the first hierarchical level. The upper-level record pointer field shows pointers pRn. Each of the pointers pRn points out the record that stores the URL transmitted immediately before the URL stored in the same record is transmitted (or the record that stores the URL belonging to the hierarchical level located immediately above the subject hierarchical level). Here, n represents the record number.

The lower-level list pointer field shows pointers pLm. Each of the pointers pLm points out the list that stores the pointer pRn pointing out the record that stores the URL transmitted after the URL stored in the same record is transmitted (or the record that stores the URL belonging to the hierarchical level located immediately below the subject hierarchical level). Here, the lower hierarchical level is the mth hierarchical level. If the URL stored in the same record is the entry, the value “NULL” is stored in the corresponding upper-level record pointer field. If the URL stored in the same record belongs to the lowermost hierarchical level, the value “NULL” is stored in the corresponding lower-level list pointer field.

Table 4 shown in FIG. 10B is a table formed by extracting the information stored in the record that stores the entry, from Table 3 that is the server list. Accordingly, Table 4 will be hereinafter also referred to as the entry list.

Like Table 3, Table 4 has a site field, a source file field, a numeric value field, and a lower-level record pointer field. The information stored in each field of Table 4 is the same as the information stored in each corresponding field of Table 3. In other words, the records of Table 4 do not store any information that is not stored in the records of Table 3.

Table 52 shown in FIG. 10C shows pointers pRn pointing out the records that store the URLs belonging to the second hierarchical level. The value “NULL” serving as the information indicating the top and the bottom of the list is stored at the top and the bottom of the list. Table 53 shown in FIG. 10D and Table 54 shown in FIG. 10E show the information about the URLs belonging to the third and fourth hierarchical levels, respectively, like Table 52 shown in FIG. 10C. Therefore, explanation of Table 53 and Table 54 is omitted here.

Although not mentioned above for convenience sake, the server list of Table 3 associates the extracted URLs with the business tasks executed to transmit the URLs, because there are URLs transmitted for two or more business tasks, like the URL 11.

The memory unit 1113 also stores a transition pattern list and site lists that associate the business tasks with the URLs to be transmitted according to the business tasks, based on the business task executing order and the URL transmitting order.

The transition pattern list shows the transitions between business tasks. The site lists show the transitions between transmitted URLs. More specifically, in a case where the URLs are the information indicating the site of the HTTP server and the site of the server of the Web page to be transmitted by the HTTP server (or a storage directory or the like), the site lists show the transitions of the Web pages to be displayed by the terminal device 1390 or 2090. The transition pattern list and the site lists are formed based on the site list described with reference to FIGS. 10A through 10E.

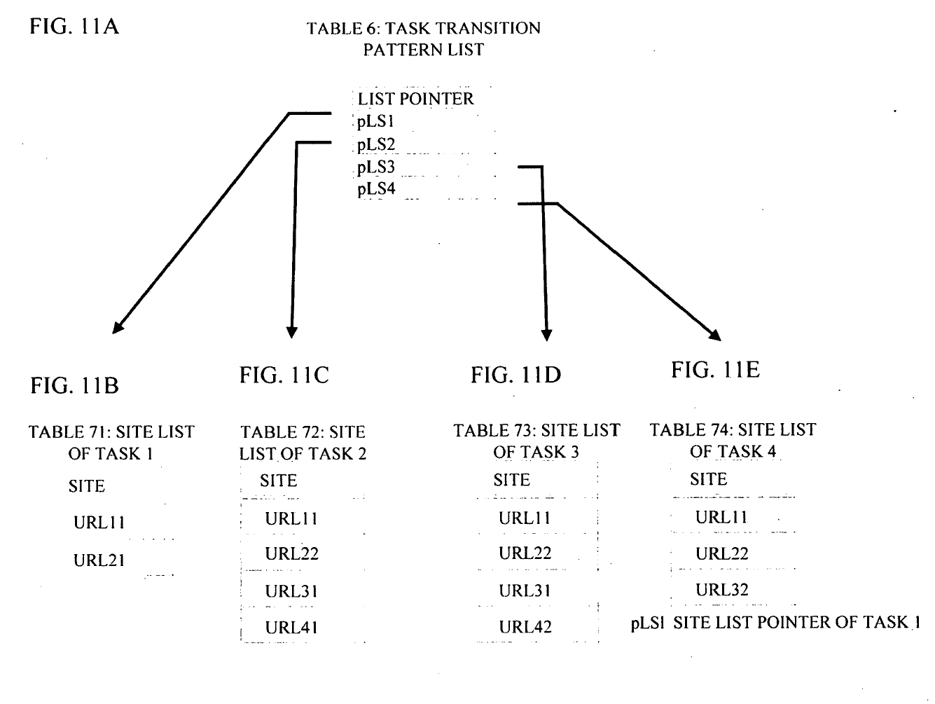

Referring now to FIGS. 11A through 11E, the transition pattern list and the site lists stored in the memory unit 1113 are described. FIGS. 11A and 11E show examples of the transition pattern list and the site lists stored in the memory unit 1113.

Table 6 shown in FIG. 11A is an example of the transition pattern list. Table 6 stores pointers pLSI in the task executing order. Each of the pointers pLSI points out the site list storing the URL transmitted through execution of the corresponding business task. Here, I represents the task execution sequential number. More specifically, the transition pattern list of Table 6 stores the pointers pLS1, pLS2, pLS3, and pLS4 in the first, second, third, and last records, respectively. The pointers pLS1, pLS2, pLS3, and pLS4 point out the site lists that store the URLs to be transmitted through execution of the business tasks 1, 2, 3, and 4.

Table 71 shown in FIG. 11B is an example of the site list of the business task 1. The site list of the business task 1 shows the URLs to be transmitted through execution of the business task 1 in the transmitting order. Like Table 71 shown in FIG. 11B, Tables 72 through 74 shown in FIGS. 11C through 11E are examples of the site lists of the business tasks 2 through 4.

Referring back to FIG. 4, explanation of the structure of the transmission device 1110 is now resumed.

The extracting unit 1114 is connected to the receiving unit 1111, the memory unit 1113, the retrieving unit 1115, and the associating unit 1116. The extracting unit 1114 performs the later described extracting operation. By doing so, the extracting unit 1114 extracts, from the execution logs, the information indicating the site transferred with the argument stored in the memory unit 1113 in association with the executed transmitting operation and the argument retrieved by the retrieving unit 1115 described later.

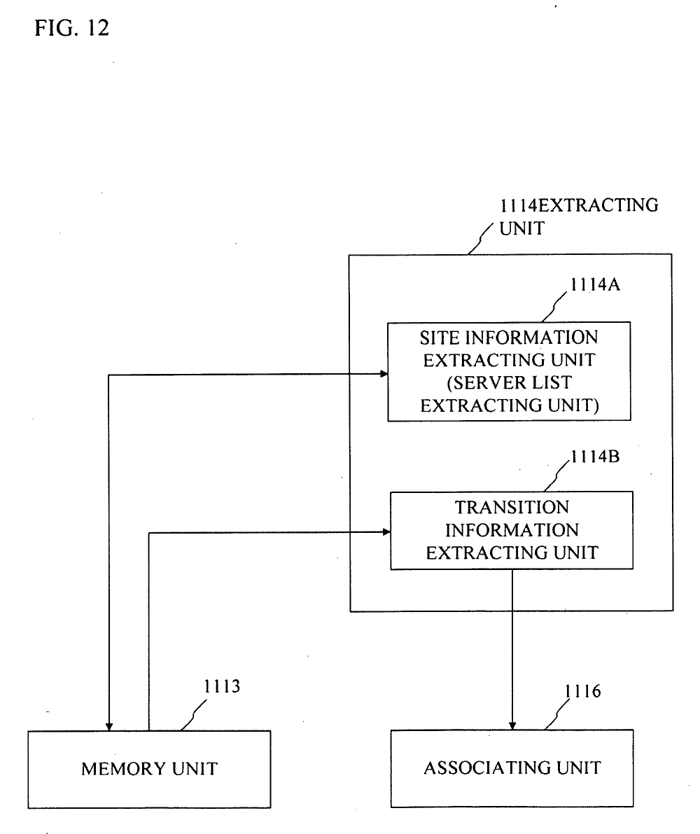

Referring now to FIG. 12, the structure of the extracting unit 1114 is described. FIG. 12 is a functional block diagram showing an example structure of the extracting unit 1114.

The extracting unit 1114 includes a site information extracting unit 1114A and a transition information extracting unit 1114B. The site information extracting unit 1114A is connected to the memory unit 1113. The site information extracting unit 1114A performs a site information extracting operation to extract the server list as the site information from the execution logs. Therefore, the site information extracting unit 1114A will be hereinafter also referred to as the server list extracting unit 1114A.

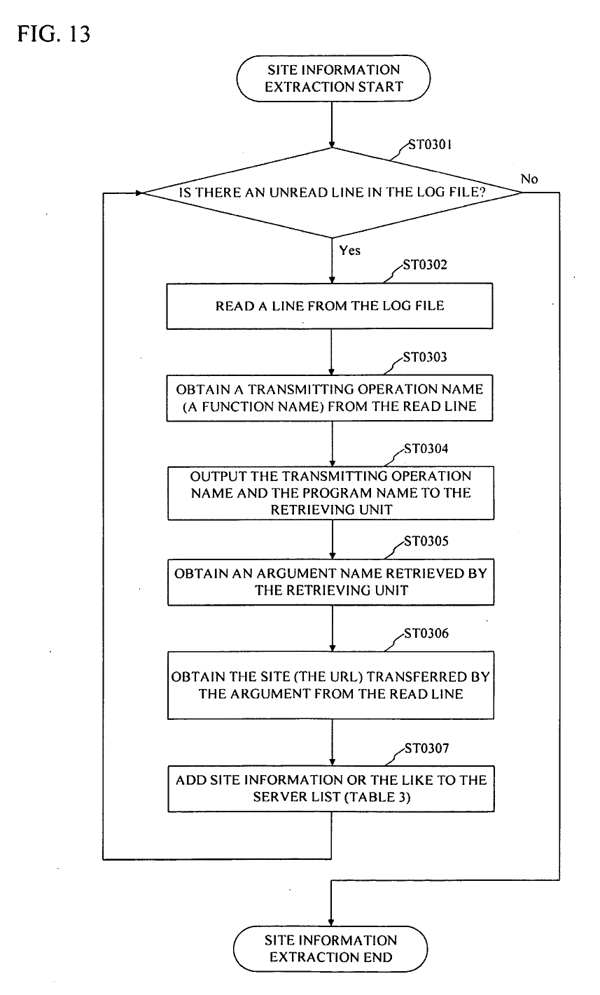

Referring now to FIG. 13, the site information extracting operation to be performed by the site information extracting unit 1114A is described. FIG. 13 is a flowchart showing an example of the site information extracting operation to be performed by the site information extracting unit 1114A.

First, the site information extracting unit 1114A determines whether any unread lines exist in the log file of the execution logs stored in the memory unit 1113 (step ST0301). If there are unread lines, the site information extracting unit 1114A carries out the procedure of step ST0302. If not, the site information extracting unit 1114A ends the site information extracting operation. The execution logs to be subjected to the processing will be described later in the description of an extracting operation.

When determining that there are unread lines in step ST0301, the site information extracting unit 1114A reads the uppermost one of the unread lines from the log file (step ST0302). The site information extracting unit 1114A then obtains the name of the transmitting operation (or the name of the transmission function) from the read line (step ST0303). This procedure may be carried out on the assumption that the name of the transmitting operation is written at a predetermined location on the lines forming the log file.

After that, the site information extracting unit 1114A outputs the obtained transmitting operation name and the program name to the retrieving unit 1115 (step ST0304). The site information extracting unit 1114A then obtains the argument name retrieved by the retrieving unit 1115 (from Table 2, which is the rule table) (step ST0305). After that, the site information extracting unit 1114A obtains the site (or the URL) transferred with the argument under the obtained argument name (step ST0306). The site information extracting unit 1114A then adds the information indicating the site or the like to Table 3, which is the server list (step ST0307). After that, the site information extracting unit 1114A returns to step ST0301, and repeats the above procedures.

With this arrangement, the transmitting operations for transmitting the sites of the support devices that support business tasks are associated with the arguments to be used for transferring the sites for the transmitting operations. Accordingly, based on the transmitting operations and the arguments stored in association with each other, the information indicating each transmitted support device site can be efficiently extracted from the information transferred with the arguments to the executed transmitting operations.

Referring back to FIG. 12, explanation of the structure of the extracting unit 1114 is now resumed.

The transition information extracting unit 1114B is connected to the memory unit 1113 and the associating unit 1116. The transition information extracting unit 1114B performs a transition information extracting operation to extract transition information indicating the transition among the URLs representing sites. More specifically, the transition information indicates the URLs transmitted before and after the transmission of the URL representing the site extracted by the site information extracting unit 1114A.

An example of the transition information extracting operation to be performed by the transition information extracting unit 1114B is now described.

First, the transition information extracting unit 1114B extracts the records with the value “ON” in the entry flag field from the server list of Table 3 stored in the memory unit 1113. The transition information extracting unit 1114B then adds the information about the extracted records to the entry list shown in Table 4.

This procedure can be carried out by extracting (selecting) the records in the server list of Table 3 that satisfy the condition that the flag value in the entry field is “ON”, with the use of SQL (Structured Query Language) or the like.

After that, the transition information extracting unit 1114B follows the function calls written in the execution logs by the same number as the number of entries stored in the records registered in the entry list. In this manner, the transition information extracting unit 1114B obtains the transition information. The transition information extracting unit 1114B then adds the information about the previous connection server and the information about the next connection server to the server list.

More specifically, the transition information extracting unit 1114B first reads the execution logs line by line, and extracts the URLs transferred to the executed functions written in the read lines. The transition information extracting unit 1114B then stores the record pointer pRn pointing out the record of the site list showing the URL that is extracted when one line of the execution logs is read last time. Here, the record pointer pRn is stored in the higher-level record pointer field of the site list showing the URL that is extracted this time. In the case of an entry, the transition information extracting unit 1114B writes the value “NULL” in the higher-level record pointer field.

The transition information extracting unit 1114B also adds the pointer pRn that points out the record storing the URL extracted this time to the lower-level list of the mth hierarchical level. The transition information extracting unit 1114B further adds the pointer pLm that points out the list having the pointer added thereto this time, to the lower-level list pointer of the record storing the URL extracted last time. In the case of the lowermost level, the transition information extracting unit 1114B writes the value “NULL” into the lower-level list pointer.

In this embodiment, the transition information is extracted based on the relationship between the previous line and the next line. Since the relationship between the previous line and the next line is the same as the relationship between the previous execution time and the next execution time, the above description also applies to a case where the transmission information is extracted based on the relationship between the previous execution time and the next execution time.

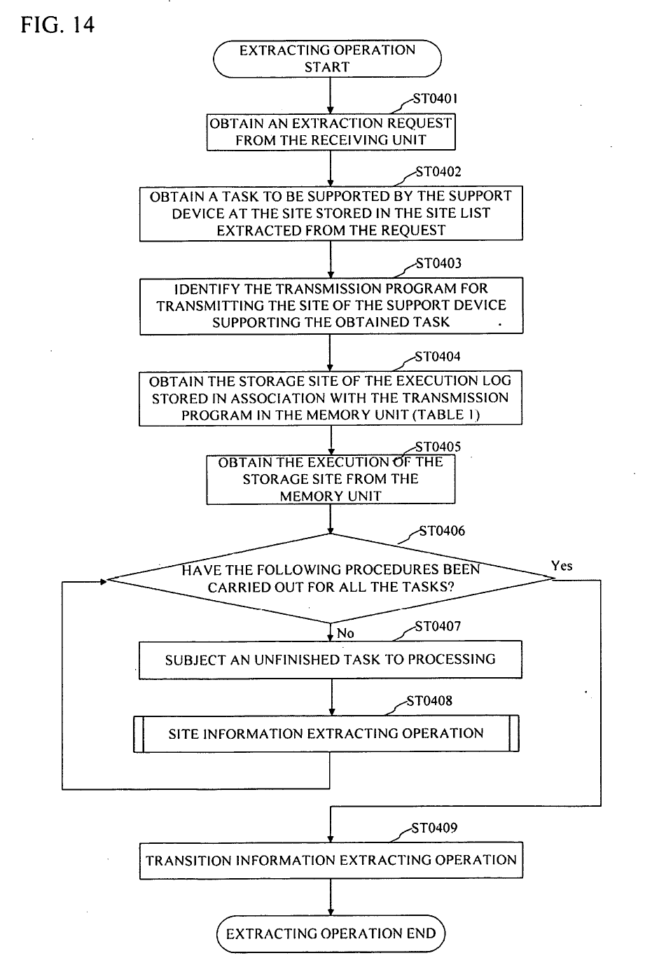

Referring now to FIG. 14, the extracting operation to be performed by the extracting unit 1114 is described. FIG. 14 is a flowchart showing an example of the extracting operation to be performed by the extracting unit 1114.

First, the extracting unit 1114 receives an extraction request from the receiving unit 1111 (step ST0401). The extracting unit 1114 obtains the business tasks to be supported by the support devices 1120 through 1140 located at the sites stored in the site list extracted from the request (step ST0402).

After that, the extracting unit 1114 identifies the transmission program for transmitting the sites of the support devices 1120 through 1140 that support the obtained business tasks (step ST0403). The extracting unit 1114 then obtains the storage directory of the execution logs stored in Table 1 associated with the transmission programs in the memory unit 1113 (step ST0404). The extracting unit 1114 obtains the execution logs of the transmission programs stored in the obtained directory (step ST0405).

The extracting unit 1114 then determines whether the following procedures have been carried out for all the business tasks in accordance with the transmission program (step ST0406). If the extracting unit 1114 determines that the following procedures have been carried out for all the business tasks, the extracting unit 1114 carries out the procedure of step ST0409. If the extracting unit 1114 determines that the following procedures have not been carried out for all the business tasks, the extracting unit 1114 carries out the procedure of step ST0407.

If the extracting unit 1114 determines in step ST0406 that the following procedures have not been carried out for all the business tasks, the extracting unit 1114 subjects the first one of the unfinished business tasks to the processing (step ST0407). The extracting unit 1114 then performs the site information extracting operation to extract the write information showing the site transmitted through the subject processing (step ST0408). After that, the extracting unit 1114 returns to step ST0406, and repeats the above procedures.

If the extracting unit 1114 determines in step ST0406 that the procedures have been carried out for all the business tasks, the extracting unit 1114 performs the transition information extracting operation to extract the transition information (step ST0409). After that, the extracting unit 1114 ends the extracting operation.

Referring back to FIG. 4, explanation of the structure of the transmission device 1110 is now resumed.

The retrieving unit 1115 is connected to the memory unit 1113 and the extracting unit 1114. The retrieving unit 1115 performs a retrieving operation to retrieve the argument to be used for transferring the sites stored in the memory unit 1113 in association with the executed transmitting operations.

An example of the retrieving operation to be performed by the retrieving unit 1115 is now described.

First, the retrieving unit 1115 obtains a transmission operation name and a program name from the extracting unit 1114. The retrieving unit 1115 then retrieves the argument name associated with the transmission operation name and the program name from the rule table of Table 2 stored in the memory unit 1113. The argument retrieved by the retrieving unit 1115 is the argument to be used for transferring the site, and is the information to be stored in the object field. After that, the retrieving unit 1115 outputs the retrieved argument name to the extracting unit 1114. The retrieving unit 1115 then ends the retrieving operation.

The associating unit 1116 is connected to the memory unit 1113 and the extracting unit 1114. The associating unit 1116 performs an associating operation to associate the site of each support device and the site of the next support device extracted by the extracting unit 1114 with the business tasks to be supported by the devices. By doing so, the associating unit 1116 generates a site list.

The associating unit 1116 also generates a transition pattern list and a site list that associate the URLs representing the sites stored in the server list extracted by the extracting unit 1114 with the business tasks to be supported by the support devise located at the sites represented by the URLs and the business tasks for transmitting the URLs, based on the URL transmitting order and the task performing order.

An example of the operation to be performed by the associating unit 1116 is now described.

First, the associating unit 1116 generates the transition pattern list. The associating unit 1116 then subjects the first one of the unfinished business tasks to the processing. After that, the associating unit 1116 generates a new site list, and adds the pointer pLSI pointing out the new list to the last spot in the transition pattern list.

After that, the associating unit 1116 performs an associating operation to generate site lists associated with the URLs based on the transmitting order. The associating unit 1116 then returns to the procedure for subjecting the first one of the unfinished business tasks to the processing, and repeats the above procedures.

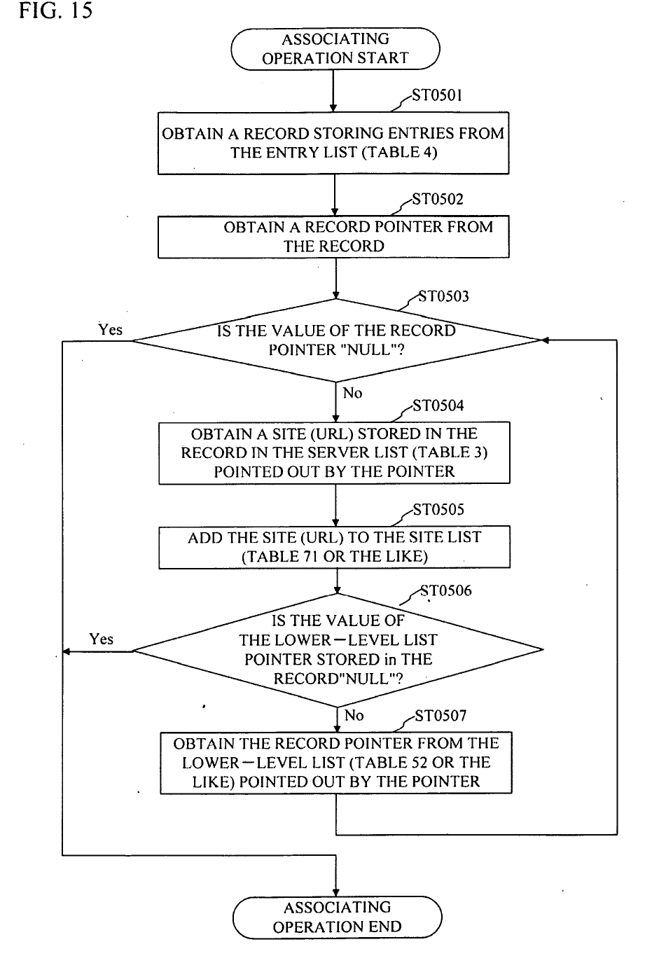

Referring now to FIG. 15, the associating operation to be performed by the associating unit 1116 is described. FIG. 15 is a flowchart showing an example of the associating operation to be performed by the associating unit 1116.

First, the associating unit 1116 obtains the record storing the entry to be transmitted in the subject processing from the entry list of Table 4 (step ST0501). After that, the associating unit 1116 obtains the record pointer of the record forming Table 3, which is a server list, from the obtained record (step ST0502).

The associating unit 1116 then determines whether the value of the record pointer is “NULL” (step ST0503). If the associating unit 1116 determines that the value of the record pointer is “NULL”, the associating unit 1116 ends the associating operation. If not, the associating unit 1116 carries out the procedure of step ST0504.

If the associating unit 1116 determines in step ST0503 that the value of the record pointer is not “NULL”, the associating unit 1116 obtains the site (or the URL) stored in the record of the server list of Table 3 pointed out by the pointer (step ST0504). The associating unit 1116 then adds the site (or the URL) to a site list such as Table 71 (step ST0505). After that, the associating unit 1116 determines whether the value of the lower-level list pointer stored in the record is “NULL” (step ST0506). If the associating unit 1116 determines that the value of the lower-level list pointer is “NULL”, the associating unit 1116 ends the associating operation. If not, the associating unit 1116 carries out the procedure of step ST0507.

If the associating unit 1116 determines in step ST0506 that the value of the lower-level list pointer is not “NULL”, the associating unit 1116 obtains the record pointer corresponding to the subject processing from the lower-level list such as Table 52 pointed out by the pointer (step ST0507). After that, the associating unit 1116 returns to step ST0503, and repeats the above procedures.

With this structure, not only the transmitted site of a support device but also the site of the support device to support the next business task is associated with the business task to be supported. Accordingly, the information indicating the sites of the support devices can be extracted and generated based on the task supporting order.

Lastly, an example of the information extracting operation to be performed by the information extraction device 1110 (the same device as the transmission device 1110 in this embodiment) to realize the information extracting function is described.

First, the information extraction device 1110 performs the above described receiving operation. The information extraction device 1110 then performs the above described extracting operation and the above described retrieving operation. After that, the information extraction device 1110 performs the above described associating operation. The information extraction device 1110 then performs the above described transmitting operation. After that, the information extraction device 1110 ends the information extracting operation.

Referring back to FIG. 1, explanation of the connection system 10 is now resumed, starting from the description of the structure of the business system 1100.

The support devices 1120 through 1140 are formed with personal computers or server devices, for example, and are connected to the firewall 1161. The support devices 1120 through 1140 support execution of business tasks at the terminal device 1390 or 2090.

More specifically, the support devices 1120 through 1140 are an application server, an authentication server, and a DB server. The support device 1120 serving as the application server receives an operation from the transmission device 1110 serving as the HTTP server that has received a request for provision of a function. The support device 1120 then performs information processing on the information stored in the support device 1140 serving as the DB server. By doing so, the support device 1120 supports execution of a business task. The support device 1130 serving as the authentication server receives an authentication request transmitted from the transmission device 1110 serving as the HTTP server. The support device 1130 then authenticates the right of the user who is about to use the terminal device 1390 or 2090. More specifically, the support device 1130 determines whether the user has the right to refer to, modify, erase, or add information to the information stored in the support device 1140 serving as the DB server. The support device 1140 serving as the DB server manages the information that is handled in business tasks and has disclosure restrictions set thereon. The information managed by the support device 1140 is referred to by the support device 1120 serving as the application server.

The firewall 1161 is connected to the firewall 1061, the transmission device 1110, and the support devices 1120 through 1140. The structure and functions of the firewall 1161 are the same as the structure and functions of the firewall 1061, and therefore, explanation of them is omitted here.

Next, the relay system 1200 is described.

The proxy device 1210, the mail server 1220, and the DNS server 1230 are formed with personal computers or server devices on which programs such as Squid, Postfix and Dovecot, and BIND (Berkeley Internet Name Domain) are installed. The proxy device 1210, the mail server 1220, and the DNS server 1230 are connected to the firewall 1061 and 1062.

The proxy device 1210 acts as a proxy for the in-house system 1300, and connects to the Internet 100 from a LAN environment partitioned by the firewall 1061 and the likes. The mail server 1220 and the DNS server 1230 relay the information that is transmitted from and is to be received by the mail server and the DNS server of the in-house system 1300.

Next, the in-house system 1300 is described.

The in-house system 1300 includes the mail server 1320, the DNS server 1330, and the terminal device 1390. The structures of the mail server 1320 and the DNS server 1330 are the same as the structures of the mail server 1220 and the DNS server 1230 of the relay system 1200, and therefore, only the different aspects will be described in the following. The mail server 1320 provides the function to deliver electronic mail in response to a request from the terminal device 1390. The DNS server 1230 provides the function to notify an IP address associated with a domain name in response to a request from the terminal device 1390.

The terminal device 1390 is formed with a personal computer, for example. The terminal device 1390 executes business tasks, supported by the business system 1100 connected to the terminal device 1390 via the mail server 1320, the DNS server 1330, and the proxy device 1210, or by the respective servers of the external system 2000. Therefore, the terminal device 1390 will be hereinafter also referred to as the client. The terminal device 1390 connects to the external system 2000 for personal activities such as viewing a Web site, and receives the functions of the devices in the external system 2000.

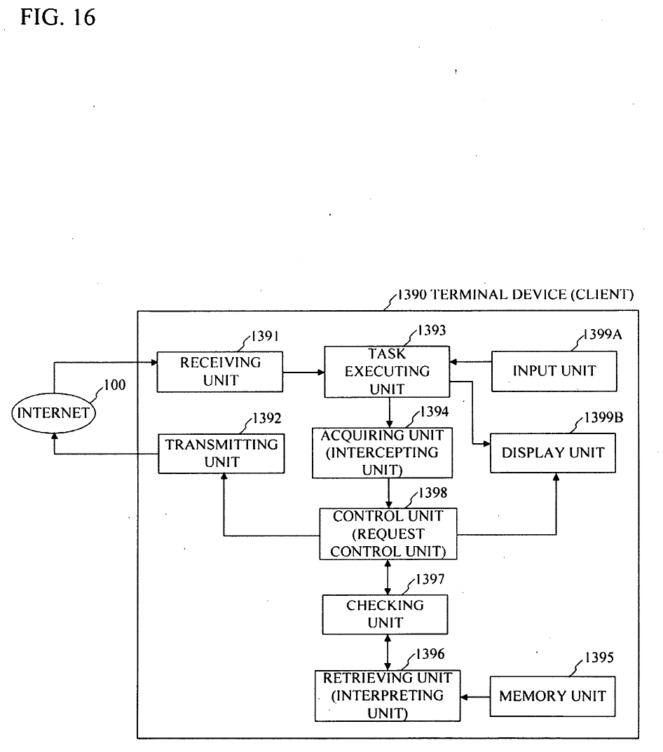

Referring now to FIG. 16, the structure of the terminal device 1390 is described. FIG. 16 is a functional block diagram showing an example structure of the terminal device 1390.

The terminal device 1390 includes a receiving unit 1391, a transmitting unit 1392, a task executing unit 1393, an acquiring unit 1394, a memory unit 1395, a retrieving unit 1396, a checking unit 1397, a control unit 1398, an input unit 1399A, and a display unit 1399B. The functions of the task executing unit 1393, the acquiring unit 1394, the retrieving unit 1396, the checking unit 1397, and the control unit 1398 are realized by software processing performed by the terminal device 1390. The hardware structure used by the terminal device 1390 to perform the software processing is the same as the hardware structure used by the transmission device 1110 to perform software processing, and therefore, explanation of it is omitted here.

The receiving unit 1391 is formed with a network card, for example, and is connected to the task executing unit 1393. The receiving unit 1391 performs a receiving operation to receive various kinds of information, and outputs the received information to the task executing unit 1393. The information received by the receiving unit 1391 includes the information indicating a URL representing a site of the support devices 1120 through 1140 and the information for supporting execution of business tasks transmitted in response to transmission requests transmitted from the transmitting unit 1392. The information received by the receiving unit 1391 may be in the form of Web pages, for example.

Like the receiving unit 1391, the transmitting unit 1392 is formed with a network card, for example, and is connected to the control unit 1398. The transmitting unit 1392 performs a transmitting operation to transmit various kinds of information including requests for provision for functions under the control of the control unit 1398.

The task executing unit 1393 is connected to the receiving unit 1391, the acquiring unit 1394, the input unit 1399A, and the display unit 1399B. The task executing unit 1393 executes a program such as a Web browser, to perform a business task with the use of the information for supporting execution of business tasks obtained from the receiving unit 1391.

An example of the operation to be performed by the task executing unit 1393 is now described.

First, the task executing unit 1393 obtains a transmission request from the input unit 1399A. The task executing unit 1393 then outputs the transmission request not only to the transmitting unit 1392 but also to the acquiring unit 1394. After that, the task executing unit 1393 obtains, from the receiving unit 1391, the URL transmitted in response to the output transmission request. The task executing unit 1393 then outputs a support request to the acquiring unit 1394 to request supports for execution of business tasks from the support devices 1120 through 1140 located at the site represented by the obtained URL.

If the transmitting unit 1392 transmits a support request as described later, the task executing unit 1393 establishes a connection with the support devices 1120 through 1140, and obtains the information for supporting execution of business tasks from the receiving unit 1391, and outputs the obtained information to the display unit 1399B. By doing so, the task executing unit 1393 executes business tasks. If the transmitting unit 1392 does not transmit a support request, the task executing unit 1393 does not establish a connection, and executes business tasks without a support.

If a request that is input for personal viewing of a Web page or the like is obtained from the input unit 1399A, for example, the task executing unit 1393 outputs the obtained request to the acquiring unit 1394. After that, as the transmitting unit 1392 transmits a support request as described later, the task executing unit 1393 obtains the information such as a Web page or electronic mail requested through the receiving unit 1391, and outputs the obtained information to the display unit 1399B.

The acquiring unit 1394 is connected to the task executing unit 1393 and the control unit 1398. The acquiring unit 1394 performs an acquiring operation to obtain the request to be output from the task executing unit 1393 to the transmitting unit 1392. After that, the acquiring unit 1394 outputs the obtained request to the control unit 1398.

More specifically, the acquiring program specifying the execution procedures of the acquiring operation to be performed by the acquiring unit 1394 is a function enhancement program (so-called “plug-in”) that is to be incorporated into the Web browser to be executed by the task executing unit 1393 and add functions. If the acquiring unit 1394 does not execute the plug-in program, the task executing unit 1393 outputs a request directly to the transmitting unit 1392. However, if the acquiring unit 1394 executes the plug-in program, the request that is output from the task executing unit 1393 to the transmitting unit 1392 is acquired by the acquiring unit 1394 in an interceptive manner. Therefore, the acquiring unit 1394 will be hereinafter also referred to as the intercepting unit.

With this structure, the acquiring unit 1394 executes the function enhancement program to obtain the request to be output from the task executing unit 1393 to the transmitting unit 1392. Accordingly, connections can be restricted without a change in the program executed by the task executing unit 1393. Furthermore, a decrease in the usability of the terminal device 1390 can be prevented.

The memory unit 1395 is connected to the retrieving unit 1396. The memory unit 1395 stores the transition pattern list and site lists extracted by the transmission device 1110 having the information extracting function.

The retrieving unit 1396 performs the later described retrieving operation to retrieve the site list that stores the sites of the support devices 1120 through 1140, is associated with the business task to be supported in response to a request, and is stored in the memory unit 1395.

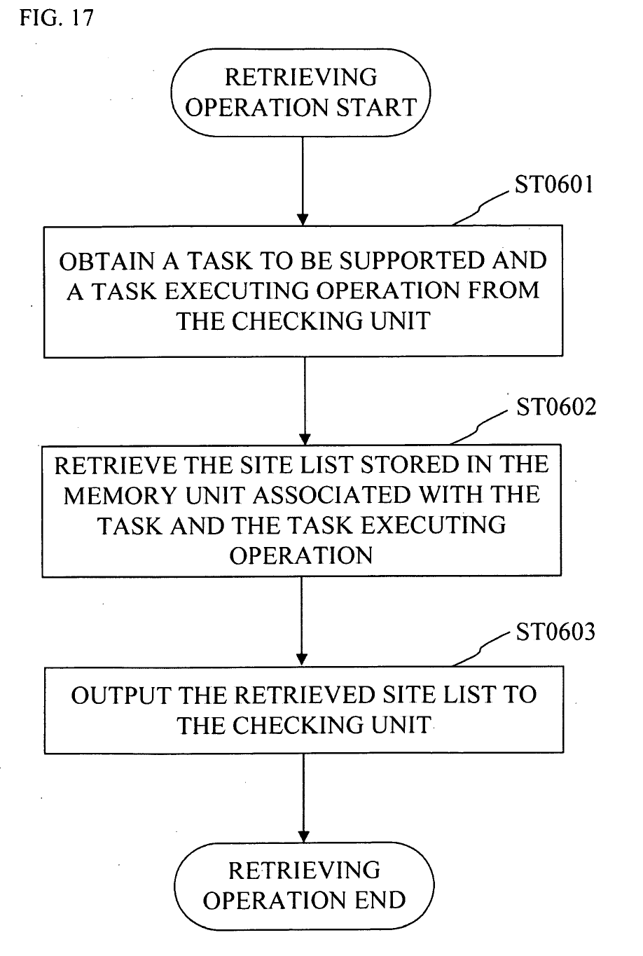

Referring now to FIG. 17, an example of the retrieving operation to be performed by the retrieving unit 1396 is described. FIG. 17 is a flowchart showing an example of the retrieving operation to be performed by the retrieving unit 1396.

First, the retrieving unit 1396 obtains a business task to be supported and a task executing operation from the checking unit 1397 (step ST0601). The retrieving unit 1396 then retrieves the site list that is stored in the memory unit 1395 and is associated with the obtained task and the task executing operation (step ST0602). After that, the retrieving unit 1396 outputs the retrieved site list to the checking unit 1397. The retrieving unit 1396 then ends the retrieving operation.

Referring back to FIG. 16, explanation of the structure of the terminal device 1390 is now resumed.

The checking unit 1397 is connected to the control unit 1398 and the retrieving unit 1396. The checking unit 1397 performs the later described checking operation, to check the URL representing a requested transmission destination against the URLs stored in the site list retrieved by the retrieving unit 1396.

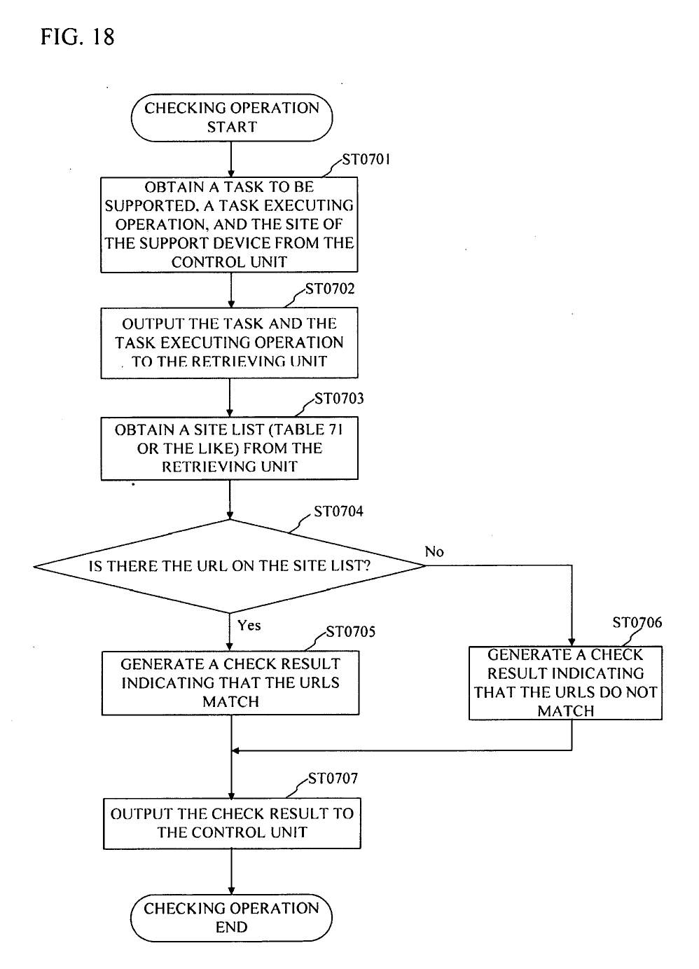

Referring now to FIG. 18, the checking operation to be performed by the checking unit 1397 is described. FIG. 18 is a flowchart showing an example of the checking operation to be performed by the checking unit 1397.

First, the checking unit 1397 obtains a task to be supported, a task executing operation, and a site (or a URL) of the support devices 1120 through 1140 from the control unit 1398 (step ST0701). The checking unit 1397 then outputs the task and the task executing operation to the retrieving unit 1396 (step ST0702). After that, the checking unit 1397 obtains the site list retrieved by the retrieving unit 1396 (step ST0703). The checking unit 1397 then determines whether the site representing URL obtained from the control unit 1398 is included in the site list retrieved by the retrieving unit 1396 (step ST0704). If the URL is included in the site list, the checking unit 1397 carries out the procedure of step ST0705. If not, the checking unit 1397 carries out the procedure of step ST0706.

If the checking unit 1397 determines in step ST0704 that the obtained URL is included in the site list, the checking unit 1397 generates a check result indicating that the URLs match (step ST0705). The checking unit 1397 then moves on to step ST0707.

If the checking unit 1397 determines in step ST0704 that the obtained URL is not included in the site list, the checking unit 1397 generates a check result indicating that the URLs do not match (step ST0706). The checking unit 1397 then moves on to step ST0707.

After carrying out the step ST0705 or step ST0706, the checking unit 1397 outputs the check result to the control unit 1398 (step ST0707). The checking unit 1397 then ends the checking operation.

Referring back to FIG. 16, explanation of the structure of the terminal device 1390 is now resumed.

The control unit 1398 is connected to the transmitting unit 1392, the acquiring unit 1394, the checking unit 1397, and the display unit 1399B. The control unit 1398 performs the later described control operation to control connections to devices that transmit requests.

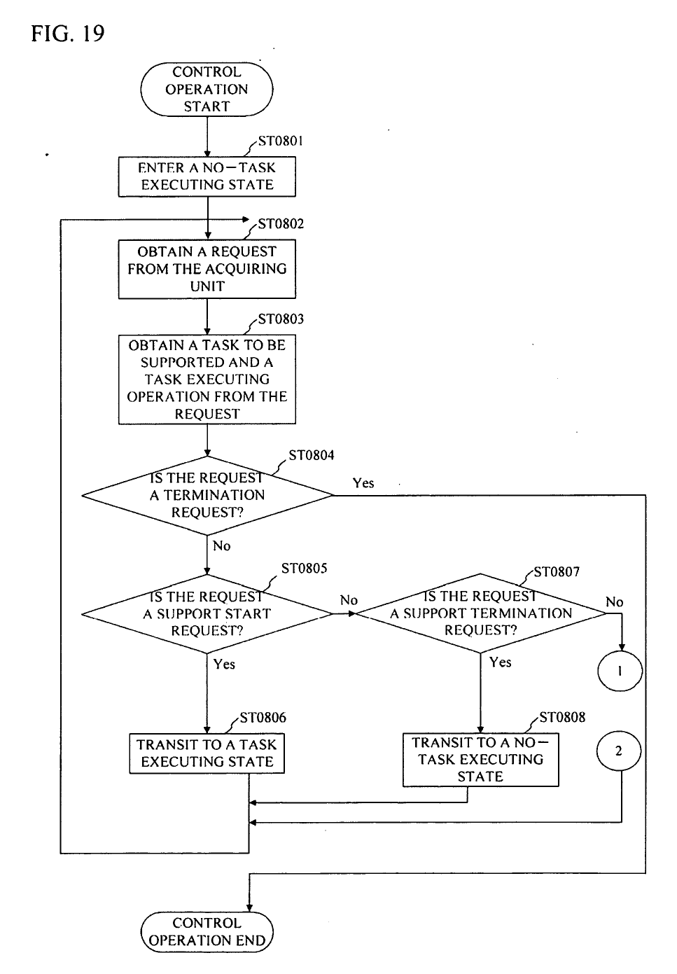

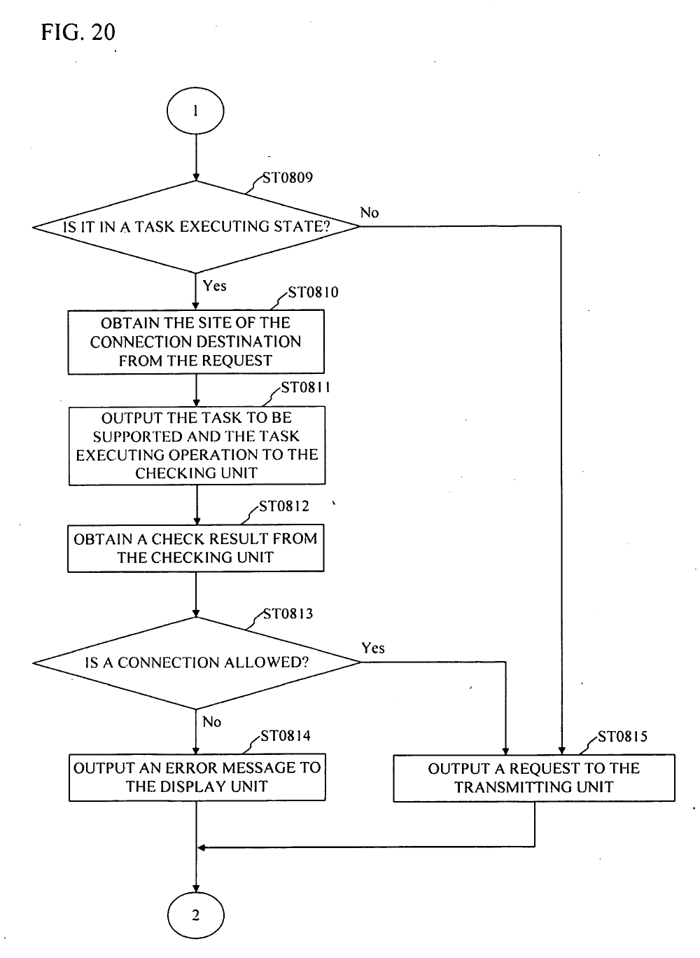

Referring now to FIGS. 19 and 20, the control operation to be performed by the control unit 1398 is described. FIG. 19 is a flowchart showing a part of an example of the control operation to be performed by the control unit 1398. FIG. 20 is a flowchart showing the other part of the example of the control operation to be performed by the control unit 1398.

First, the control unit 1398 sets the variable indicating the state of the terminal device 1390 at the value representing a no-task executing state (step ST0801). The control unit 1398 then obtains a request from the acquiring unit 1394 (step ST0802). After that, the control unit 1398 obtains the task to be supported and the task executing operation from the request (step ST0803). The control unit 1398 then determines whether the request is a termination request to terminate the execution of the control operation (step ST0804). If the request is a termination request, the control unit 1398 ends the control operation. If not, the control unit 1398 carries out the procedure of step ST0805.

If the control unit 1398 determines in step ST0804 that the request is not a termination request, the control unit 1398 determines whether the request is a request for a start of a task support (hereinafter referred to simply as a support start request) (step ST0805). If the request is a support start request, the control unit 1398 carries out the procedure of step ST0806. If not, the control unit 1398 carries out the procedure of step ST0807. A support start request is the above described transmission request in this embodiment, but the present invention is not limited to this arrangement.

If the control unit 1398 determines in step ST0805 that the request is a support start request, the control unit 1398 changes the variable to the value representing a task executing state (step ST0806). The control unit 1398 then outputs the support start request to the transmitting unit 1392. After that, the control unit 1398 returns to step ST0802, and repeats the above procedures.

If the control unit 1398 determines in step ST0805 that the request is not a support start request, the control unit 1398 determines whether the request is a request for an end of a task support (hereinafter referred to simply as a support termination request) (step ST0807). If the request is a support terminal request, the control unit 1398 carries out the procedure of step ST0808. If not, the control unit 1398 carries out the procedure of step ST0809.

If the control unit 1398 determines in step ST0807 that the request is a support termination request, the control unit 1398 changes the variable to the value representing a no-task executing state (step ST0808). The control unit 1398 then outputs the support termination request to the transmitting unit 1392. After that, the control unit 1398 returns to step ST0802, and repeats the above procedures.

If the control unit 1398 determines in step ST0807 that the request is not a support termination request, the control unit 1398 determines whether the value of the variable is the value representing a task executing state (step ST0809). If the value of the variable is the value representing a task executing state, the control unit 1398 carries out the procedure of step ST0810. If not, the control unit 1398 carries out the procedure of step ST0815.

If the control unit 1398 determines in step ST0809 that the value of the variable is the value representing a task executing state, the control unit 1398 obtains the site (or the URL) of the connection destination from the request (step ST0810). The control unit 1398 then outputs the task to be supported and the task executing operation for transmitting the URL to the checking unit 1397 (step ST0811). After that, the control unit 1398 obtains the check result from the checking unit 1397 (step ST0812). The control unit 1398 then determines whether a connection is to be allowed based on the check result (step ST0813). If a connection is to be allowed, the control unit 1398 carries out the procedure of step ST0814. If a connection is not to be allowed, the control unit 1398 carries out the procedure of step ST0815. The control unit 1398 determines that a connection should be allowed, if the obtained check result indicates that the URLs match.

If the control unit 1398 determines in step ST0813 that a connection is not to be allowed, the control unit 1398 does not output the request to the transmitting unit 1392, so as to control the transmitting unit 1392 not to transmit the request. The control unit 1398 also outputs an error message to the display unit 1399B (step ST0814). The control unit 1398 then returns to step ST0802, and repeats the above procedures.

If the control unit 1398 determines in step ST0813 that a connection is to be allowed, the control unit 1398 outputs the request to the transmitting unit 1392, so as to control the transmitting unit 1392 to transmit the request (step ST0815). The control unit 1398 then returns to step ST0802, and repeats the above procedures.

When a support for a task is provided in this structure, a connection is established with the support device located at the site that is stored in advance and is associated with the task, but no connections are established with any other devices. Accordingly, connections to destinations can be controlled with high precision, and a decrease in usability can be prevented.

Referring back to FIG. 16, explanation of the terminal device 1390 is now resumed.

The input unit 1399A is formed with a keyboard or a touch panel, for example, and is connected to the task executing unit 1393. The input unit 1399A is operated by the user of the terminal device 1390 to input the various kinds of information including requests to the task executing unit 1393.

The display unit 1399B is formed with a liquid crystal display, for example, and is connected to the task executing unit 1393 and the control unit 1398. The display unit 1399B displays the various kinds of information that is output from the task executing unit 1393 and the control unit 1398.

Lastly, an example of the connection control operation specified by a connection control program to be executed by the terminal device 1390 is described.

First, the terminal device 1390 performs the above described task executing operation. The terminal device 1390 then performs the above described acquiring operation. After that, the terminal device 1390 performs the above described control operation, checking operation, and retrieving operation. The terminal device 1390 then performs the above described transmitting operation in accordance with the result of the checking operation. After that, the terminal device 1390 ends the connection control operation.

Referring back to FIG. 1, explanation of the structure of the connection system 10 is resumed, starting from the description of the external system 2000.

The external system 2000 includes a HTTP server 2010, an unauthorized server 2020, and the terminal device 2090. The structures of the HTTP server 2010, the unauthorized server 2020, and the terminal device 2090 are substantially the same as the structures of the transmission device 1110 serving as a HTTP server and the terminal device 1390, and therefore, explanation of them is omitted here. The unauthorized server 2020 is managed by a manager with unauthorized purposes such as the above described ones.

In this embodiment, the transmitting unit 1392 is equivalent to the transmitting unit of the claimed connection control program, the memory unit 1395 is equivalent to the first memory unit, the retrieving unit 1396 is equivalent to the first retrieving unit, and the control unit 1398 is equivalent to the control unit.

As for the claimed connection control method, the transmitting operation to be performed by the transmitting unit 1392 of this embodiment is equivalent to the transmitting step, the information storing operation of the memory unit 1395 is equivalent to the first storing step, the retrieving operation to be performed by the retrieving unit 1396 is equivalent to the first retrieving step, the control operation to be performed by the control unit 1398 is equivalent to the controlling step, the information storing operation of the memory unit 1113 is equivalent to the second storing step, the retrieving operation to be performed by the retrieving unit 1115 is equivalent to the second retrieving step, and the extracting operation to be performed by the extracting unit 1114 is equivalent to the extracting step.

### Second Embodiment

A second embodiment of the present invention concerns a connection control program for controlling connections, based on the site of a support device associated with a current business task to be supported in response to a transmitted request, and the site of the support device to be requested to provide the next support.

The connection system of the second embodiment has the same structure as the connection system 10 of the first embodiment. Therefore, the same reference numerals as those used in the first embodiment are used in the following description, and only the different aspects from the first embodiment are described.

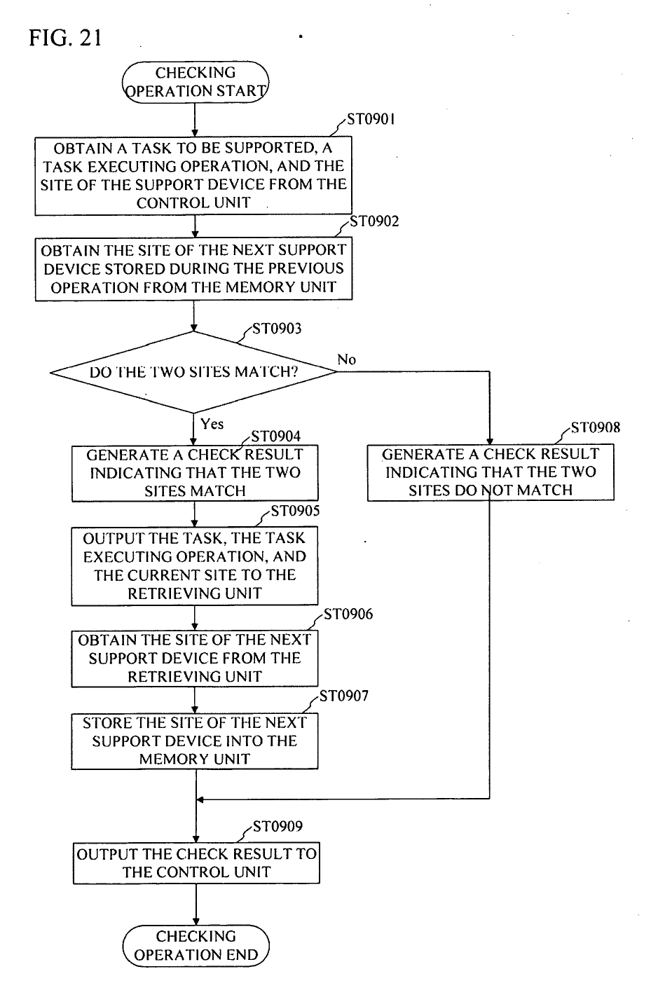

Referring first to FIG. 21, the checking operation to be performed by the checking unit 1397 in the second embodiment is described. FIG. 21 is a flowchart showing an example of the checking operation to be performed by the checking unit 1397 in the second embodiment.

First, the checking unit 1397 obtains a task to be supported, a task executing operation, and the site of the corresponding support device from the control unit 1398 (step ST0901). The checking unit 1397 then obtains, from the memory unit 1395, the site of the support device that is stored during the previous checking operation (step ST0902). In the previous operation, this support device is determined to provide the next support. The checking unit 1397 determines whether the site (or the URL) obtained from the memory unit 1395 is the same as the site obtained from the control unit 1398 (step ST0903). If the two sites match, the checking unit 1397 carries out the procedure of step ST0904. If they do not match, the checking unit 1397 carries out the procedure of step ST0908.

If the checking unit 1397 determines in step ST0903 that the two sites match, the checking unit 1397 generates a check result indicating that the two sites match (step ST0904). The checking unit 1397 then outputs the task, the task executing operation, and the site of the support device obtained from the control unit 1398, to the retrieving unit 1396 (step ST0905). After that, the checking unit 1397 obtains the site of the next support device from the retrieving unit 1396 (step ST0906). The checking unit 1397 then stores the site of the next support device into the memory unit 1395 (step ST0907). After that, the checking unit 1397 carries out the procedure of step ST0909.

If the checking unit 1397 determines in step ST0903 that the two sites do not match, the checking unit 1397 generates a check result indicating that the two sites do not match (step ST0908). The checking unit 1397 then carries out the procedure of step ST0909.

After carrying out the procedure of step ST0907 or ST0908, the checking unit 1397 outputs the check result to the control unit 1398 (step ST0909). The checking unit 1397 then ends the checking operation.

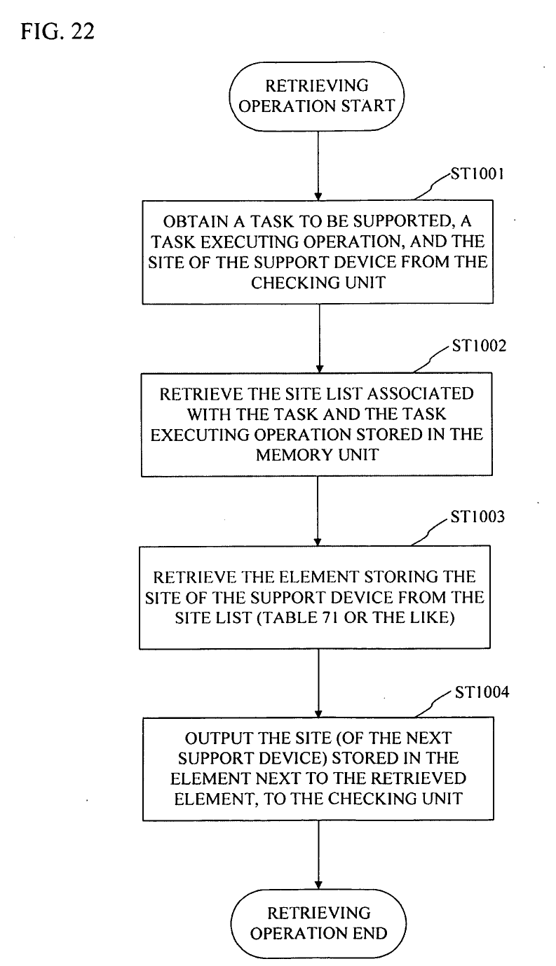

Referring now to FIG. 22, the retrieving operation to be performed by the retrieving unit 1396 in the second embodiment is described. FIG. 22 is a flowchart showing an example of the retrieving operation to be performed by the retrieving unit 1396 in the second embodiment.

First, the retrieving unit 1396 obtains a task to be supported, a task executing operation, and the site of the corresponding support device from the checking unit 1397 (step ST1001). The retrieving unit 1396 then retrieves the transition information (or the site list) associated with the task and the task executing operation stored in the memory unit 1395 (step ST1002). After that, the retrieving unit 1396 retrieves the element storing the site of the support device from the transition information (or the site list) such as Table 71 (step ST1003).

After obtaining the element next to the retrieved element (or after retrieving the element storing the site of the support device to provide the next support after the support device located at the site stored in the retrieved element provides a support), the retrieving unit 1396 outputs the site stored in the next element (or the site of the next support device) to the checking unit 1397 (step ST1004). The retrieving unit 1396 then ends the retrieving operation.

With this structure, the site of each support device is associated with the site of the support device that supports the next task. Accordingly, connections to the support devices can be controlled with high precision, based on the order of the support devices from which supports for tasks are requested.

As for the claimed connection control method, the transmitting operation to be performed by the transmitting unit 1392 of this embodiment is equivalent to the transmitting step, the information storing operation of the memory unit 1395 is equivalent to the first storing step, the retrieving operation to be performed by the retrieving unit 1396 is equivalent to the first retrieving step, the control operation to be performed by the control unit 1398 is equivalent to the controlling step, the information storing operation of the memory unit 1113 is equivalent to the second storing step, the retrieving operation to be performed by the retrieving unit 1115 is equivalent to the second retrieving step, the extracting operation to be performed by the extracting unit 1114 is equivalent to the extracting step, and the associating operation to be performed by the associating unit 1116 is equivalent to the associating step.

The information extraction device 1110 is realized by the operating unit executing a program stored in at least one of the ROM and RAM. This program may be distributed through magnetic disks, optical disks, semiconductor memories, or other recording media, or may be distributed over a network.

The connection control method of the present invention may be implemented with the use of the terminal devices 1390 and 2090. The information extraction device 1110 may be used in implementation of the following information extraction method.

This information extraction method is characterized by including: the step of storing a transmitting operation for transmitting a site in response to a request for transmission of the site of a support device that provides a support for a business task involving information on which a disclosure restriction is set, and an argument to be used for transferring the site in the transmitting operation, the argument being associated with the transmitting operation, and also storing the performed transmitting operation, the argument used in the transmitting operation, and the information transferred with the argument in association with one another; the step of retrieving the argument to be used for transferring the site stored and associated with the performed transmitting operation in the storing step; and the step of extracting the information indicating the site transferred by the argument stored and associated in the storing step with the performed transmitting operation and the argument retrieved in the retrieving step.

By this method, the transmitting operations for transmitting the sites of the support devices that support tasks are associated with the arguments to be used for transferring the sites for the transmitting operations. Accordingly, based on the transmitting operation and the arguments that are stored in association with each other, the information indicating the transmitted sites of the support devices can be efficiently extracted from the information transferred by the arguments to the executed transmitting operation.

In the above information extraction method, execution of tasks is supported by two or more support devices. In the storing step, the transmitted site of the support device is associated with the time at which the site is transmitted. In the extracting step, based on the transmitted site of the support device and the time at which the site is transmitted, the site of the next support device that supports a task after the support device supports the current task is extracted from the sites of support devices stored in the storing step. The information extraction method may further include the step of associating the task to be supported by the support device with the site of the support device and the site of the next support device extracted in the extracting step.

By this method, not only the transmitted site of the support device but also the site of the support device that is to support the next task is associated with the current task being supported. Accordingly, the site of each support device can be extracted based on the task supporting order.

Although a few preferred embodiments of the present invention have been shown and described, it would be appreciated by those skilled in the art that changes may be made in these embodiments without departing from the principles and spirit of the invention, the scope of which is defined in the claims and their equivalents.

This embodiment concerns the connection control method for controlling connections of the terminal devices 1390 and 2090 by executing a connection control program installed on the terminal devices 1390 and 2090. However, the present invention is not limited to that structure. For example, it is possible to control connections of the terminal devices 1390 and 2090 by executing a connection control program installed on the proxy device 1210 serving as a proxy server.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A connection control method comprising:
transmitting a request for provision of a function through a transmitting unit;
storing a task involving information having a disclosure restriction set thereon, and a site of a support device that provides a function to support execution of the task by processing the information, the task being associated with the site of the support device;
retrieving the site of the support device stored associated with the task to be supported in response to the request; and
restricting connections with other devices by controlling the transmitting unit to transmit the request to the support device located at the site retrieved and not to transmit the request to the other devices when the request transmitted is a request for a support for execution of the task.

2. The connection control method as claimed in claim 1, further comprising:
storing a transmitting operation to be performed by a transmission device to transmit the site in response to a request for transmission of the site of the support device, and an argument to be used for transferring the site in the transmitting operation, the argument being associated with the transmitting operation, and storing the transmitting operation performed by the transmission device, the argument used in the transmitting operation, and the information transferred by the argument in association with one another;
retrieving the argument to be used for transferring the site stored and associated with the performed transmitting operation; and
extracting information that indicates the site transferred by the argument stored and associated with the performed transmitting operation and the argument retrieved,
the site indicated by the information extracted being stored and associated with the task to be supported by the support device located at the site.

3. The connection control method as claimed in claim 2, wherein:
the execution of the task is supported by at least two support devices;
in storing a task involving information, the task and the site of the support device supporting the execution of the task are stored and associated with the site of the next support device that supports the task after the support device supports the task;
in retrieving the side of the support device, the site of the support device and the site of the next support device stored and associated with the task to be supported in response to the request are retrieved; and
in restricting connections, after the transmitting unit is controlled to transmit the request to the support device located at the site retrieved, the transmitting unit is controlled to transmit the request to the support device located at the next site and establish a connection with the next support device.

4. The connection control method as claimed in claim 3, wherein:
in storing a transmission operation, the transmitted site of the support device is associated with the time at which the site is transmitted;
in extracting information, based on the transmitted site of the support device and the time at which the site is transmitted, the site of the next support device that supports the task after the support device supports the task is extracted from the sites of support devices stored; and
the connection control method further comprises associating the task to be supported by the support device with the site of the support device and the site of the next support device extracted.

5. A connection system comprising:
a support device that provides a function to support execution of a task involving information having a disclosure restriction set thereon, the support being provided by processing the information;
a transmission device that transmits a site of the support device supporting the task, in response to a request for transmission of the site; and
a terminal device that stores the site of the support device associated with the task to be supported by the support device, and, when transmitting a request for provision of a function from the support device, transmits the request to the support device located at the site stored in association with the task to be supported in response to the request to be transmitted, and does not transmit the request to other devices.

6. The connection system as claimed in claim 5, further comprising
an information extraction device that stores a transmitting operation performed by the transmission device to transmit the site in response to the request for transmission of the site, an argument used in the transmitting operation, and information transferred by the argument, the transmitting operation being associated with the argument and the information, and extracts the information indicating the site transferred by the stored argument, based on the transmitting operation and the argument used for transferring the site in the transmitting operation,
wherein the terminal device stores the site of the support device extracted by the information extraction device associated with the task to be supported by the support device.

7. A computer readable recording medium storing a connection control program causing a computer to function as:
a transmitting unit that transmits a request for provision of a function;
a first storing unit that stores a task involving information having a disclosure restriction set thereon, and a site of a support device that provides a function to support execution of the task by processing the information, the task being associated with the site of the support device;
a first retrieving unit that retrieves the site of the support device stored in the first storing unit associated with the task to be supported in response to the request; and
a control unit that restricts connections with other devices by controlling the transmitting unit to transmit the request to the support device located at the site retrieved by the first retrieving unit and not to transmit the request to the other devices when the request transmitted by the transmitting unit is a request for a support for execution of the task.
